(19) United States
(12) Patent Application Publication
(10) Pub. No.: US 2020/0058068 A1
(43) Pub. Date: Feb. 20, 2020

(54) DYNAMIC PROVISIONING AND INITIATION OF DATA EXCHANGES BASED ON AGGREGATED CONTEXTUAL INFORMATION

(71) Applicant: The Toronto-Dominion Bank, Toronto (CA)

(72) Inventors: Rajeev Kumar GANDHI, Mississauga (CA); Robert Kyle MILLER, Mississauga (CA); Kushank RASTOGI, Toronto (CA); David Samuel TAX, Toronto (CA); Milos DUNJIC, Oakville (CA); Arthur Carroll CHOW, Markham (CA); Armon ROUHANI, Mississauga (CA); Maryam KARBASI, Toronto (CA); Kamana TRIPATHI, Toronto (CA); John Jong-Suk LEE, Toronto (CA); Arun Victor JAGGA, Toronto (CA)

(21) Appl. No.: 16/105,132

(22) Filed: Aug. 20, 2018

(51) Int. Cl. G06Q 40/02; G06Q 20/32; G06F 15/18

(52) U.S. Cl. CPC G06Q 40/02; G06F 15/18; G06Q 20/3221

(57) ABSTRACT

The disclosed exemplary embodiments include computer-implemented systems, apparatuses, and processes that, among other things, dynamically provision and initiate exchanges of data between network-connected devices and systems based on aggregated contextual information. For example, a network-connected apparatus may obtain (i) first data identifying first exchanges of data initiated during a first temporal interval, (ii) second data identifying a current parameter value of the first data exchanges, and (iii) third data identifying a status of an account involved in the first data exchanges. Based on the first, second, and third data, the apparatus may compute a value indicative of a probability of an initiation of a second data exchange involving the account during a second temporal interval. Further, when the computed value is consistent with an alert criterion, the apparatus may transmit alert data characterizing the second data exchange to a device for display within an interface.

### TECHNICAL FIELD

The disclosed embodiments generally relate to computer-implemented systems and processes that dynamically provision and initiate exchanges of data between network-connected devices and systems based on aggregated contextual information.

### BACKGROUND

Today, remittance systems and related technologies continue to evolve in response to advances in remittance processing, such as the ongoing transition from branch banking to digital or mobile banking processes performed on a desktop computer or mobile device. These innovations result in additional mechanisms for initiating, and flexibly funding, one or more remittance transactions or cross-border peer-to-peer payment transactions. These innovations also extend beyond the input and display capabilities of many mobile devices.

### SUMMARY

In some examples, an apparatus includes a communications unit, a storage unit storing instructions, and at least one processor coupled to the communications unit and the storage unit. The at least one processor is configured to execute the instructions to obtain (i) first data identifying one or more first exchanges of data initiated during a first temporal interval, (ii) second data identifying a current value of a parameter that characterizes the one or more first data exchanges, and (iii) third data identifying a status of an account involved in the one or more first data exchanges. Based on the first, second, and third data, the at least one processor is further configured to compute a value indicative of a probability of an initiation of a second exchange of data involving the account during a second temporal interval. When the computed value is consistent with at least one alert criterion, the at least one processor is also configured to generate and transmit, to a device via the communications unit, a first signal that includes alert data characterizing the second data exchange. The first signal includes information that instructs the device to display, via a display unit, a graphical representation of the alert data within a corresponding portion of an interface.

In other examples, a computer-implemented method includes obtaining, by one or more processors, (i) first data identifying one or more first exchanges of data initiated during a first temporal interval, (ii) second data identifying a current value of a parameter that characterizes the one or more first data exchanges, and (iii) third data identifying a status of an account involved in the one or more first data exchanges. Based on the first, second, and third data, the method also includes computing, by the one or more processors, a value indicative of a probability of an initiation of a second exchange of data involving the account during a second temporal interval. When the computed value is consistent with at least one alert criterion, the method further includes generating and transmitting, by the one or more processors, a first signal that includes alert data characterizing the second data exchange to a device. The first signal includes information that instructs the device to display, via a display unit, a graphical representation of the alert data within a corresponding portion of an interface.

Further, in some examples, an apparatus includes a communications unit, a storage unit storing instructions, and at least one processor coupled to the communications unit and the storage unit. The at least one processor is configured to execute the instructions to obtain (i) first data identifying one or more first exchanges of data initiated during a first temporal interval, (ii) second data identifying a current value of a parameter that characterizes the one or more first data exchanges, and (iii) third data identifying a status of an account involved in the one or more first data exchanges. Based on the first, second, and third data, the at least one processor is further configured to compute a value indicative of a probability of an initiation of a second exchange of data involving the account during a second temporal interval. When the computed value is consistent with at least one alert criteria, the at least one processor is also configured to perform operations that initiate the second data exchange in accordance with the current value of the first parameter, the second data exchange being initiated without input from a device associated with the account. In addition, the at least one processor is further configured to generate and transmit, to the device via the communications unit, a first signal that includes alert data characterizing the initiated second data exchange. The first signal includes information that instructs the device to display, via a display unit, a graphical representation of the alert data within a corresponding portion of an interface.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a diagram of an exemplary computing environment, consistent with disclosed embodiments.

FIGS. 2A and 2B are diagrams illustrating portions of an exemplary computing environment, consistent with the disclosed embodiments.

FIG. 3A is a diagram illustrating portions of an exemplary computing environment, consistent with the disclosed embodiments.

FIG. 3B is a diagram illustrating portions of an exemplary graphical user interface, consistent with the disclosed embodiments.

FIG. 3C is a diagram illustrating portions of an exemplary computing environment, consistent with the disclosed embodiments.

FIG. 3D is a diagram illustrating portions of an exemplary graphical user interface, consistent with the disclosed embodiments.

FIGS. 4 and 5 are diagrams illustrating portions of an exemplary computing environment, consistent with the disclosed embodiments.

FIGS. 6-8 are flowcharts of exemplary processes for dynamically provisioning and initiating exchanges of data between network-connected devices and systems based on aggregated contextual information.

### DETAILED DESCRIPTION

Reference will now be made in detail to the disclosed embodiments, examples of which are illustrated in the accompanying drawings. The same reference numbers in the drawings and this disclosure are intended to refer to the same or like elements, components, and/or parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the described subject matter.
I. Exemplary Computing Environments

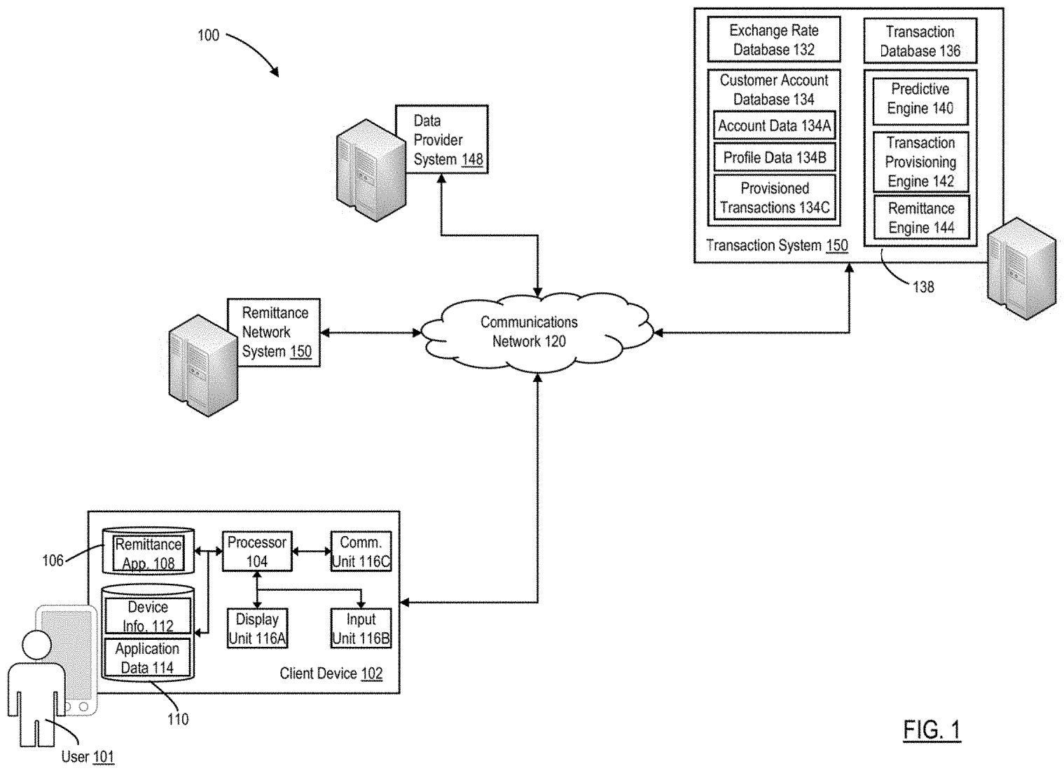

FIG. 1 is a diagram illustrating an exemplary computing environment 100, consistent with certain disclosed embodiments. As illustrated in FIG. 1, environment 100 may include one or more devices, such as client device 102 operated by user 101, a transaction system 130, one or more computing systems associated with corresponding data providers, such as data provider system 148, and one or more computing systems associated with a remittance network, such as remittance network system 150. In some instances, client device 102, transaction system 130, data provider system 148, and remittance network system 150 may be interconnected through any appropriate combination of communications networks, such as network 120. Examples of network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In other instances, network 120 may also include one or more telecommunications networks that facilitate voice communication between one or more of the network-connected devices or systems operating within environment 100, such as voice communication between client device 102 and one or more devices communicative coupled to transaction system 130 (not illustrated in FIG. 1). By way of example, network 120 may include a mobile communications network (e.g., a digital cellular network) operating in accordance with one or more digital cellular technologies, such as, but not limited to, Global System for Mobile Communications (GSM®) technologies, code-division multiple access (CDMA) technologies, General Packet Radio Service (GPRS®) technologies, or Long-Term Evolution technologies (LTE®) technologies. In other examples, network 120 may include, or represent a component of, a public switched telephone network (PSTN).

In some embodiments, client device 102 may include a computing device having one or more tangible, non-transitory memories that store data and/or software instructions, and one or more processors, e.g., processor 104, configured to execute the software instructions. The one or more tangible, non-transitory memories may, in some aspects, store application programs, application modules, and other elements of code executable by the one or more processors, e.g., within executable application data 106. For example, as illustrated in FIG. 1, client device 102 may maintain, within executable application data 106, an executable application associated with, or provided by, a financial institution associated with transaction system 130, such as remittance application 108.

Further, in some instances, executable application data 106 may also maintain one or more executable web browsers (e.g., Google Chrome™), one or more executable messaging applications (e.g., WhatsApp™), or one or more executable applications that establish voice communications between client device 102 and other network-connected devices operating within environment 100. The disclosed embodiments are, however, not limited to these exemplary application programs, and in other examples, executable application data 106 may include any additional or alternate application program, application module, and other elements of code executable by client device 102

Client device 102 may also establish and maintain, within the one or more tangible, non-tangible memories, one or more structured or unstructured data repositories or databases, e.g., data repository 110, that include device information 112 and application data 114. Device information 112 may include information that uniquely identifies client device 102, such as a media access control (MAC) address of client device 102 or an IP address assigned to client device 102. Further, in some instances, application data 114 may include information that facilitates, or supports, an execution of any of the application programs described herein, such as, but limited to, supporting information that enables executable remittance application 108 to authenticate an identity of a user operating client device 102, such as user 101 of FIG. 1. Examples of this supporting information include, but are not limited to, one or more login credentials assigned to user 101 (e.g., by transaction system 130) or one or more biometric credentials of user 101, such as fingerprint data or a digital image of a portion of user 101′s face, or other information facilitating a biometric or multi-factor authentication of user 101.

Additionally, in some examples, client device 102 may also include a display unit 116A configured to present interface elements to user 101, and an input unit 116B configured to receive input from user 101, e.g., in response to the interface elements presented through display unit 116A. By way of example, display unit 116A may include, but is not limited to, an LCD display unit or other appropriate type of display unit, and input unit 116B may include, but is not limited to, a keypad, keyboard, touchscreen, fingerprint scanner, voice activated control technologies, or appropriate type of input unit. Further, in additional instances (not depicted in FIG. 1), the functionalities of display unit 116A and input unit 116B may be combined into a single device, e.g., a pressure-sensitive touchscreen display unit that presents interface elements and receives input from user 101. Client device 102 may also include a communications unit 112C, such as a wireless transceiver device, coupled to processor 110403 and configured by processor 104 to establish and maintain communications with network 120, e.g., via WiFi®, Bluetooth®, NFC, or cellular communications protocols (e.g., LTE®, CDMA®, GSM®, etc.).

Examples of client device 102 may include, but are not limited to, a personal computer, a laptop computer, a tablet computer, a notebook computer, a hand-held computer, a personal digital assistant, a portable navigation device, a mobile phone, a smartphone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface module, consistent with disclosed embodiments.

Referring back to FIG. 1, transaction system 130, data provider system 148, and remittance network system 150 may each represent a computing system that includes one or more servers (not depicted in FIG. 1) and tangible, non-transitory memory devices storing executable code and application modules. Further, the servers may each include one or more processor-based computing devices, which may be configured to execute portions of the stored code or application modules to perform operations consistent with the disclosed embodiments.

In other instances, and consistent with the disclosed embodiments, one or more of transaction system 130, data provider system 148, and remittance network system 150 may correspond to a distributed system that includes computing components distributed across one or more networks, such as network 120, or other networks, such as those provided or maintained by cloud-service providers. In other instances, and consistent with the disclosed embodiments, one or more of transaction system 130, data provider system 148, and remittance network system 150, may correspond to a distributed system that includes computing components distributed across one or more networks, such as network 120, or other networks, such as those provided or maintained by cloud-service providers (e.g., Google Cloud™, Microsoft Azure™, etc.). Additionally, in some instances, one or more of transaction system 130, data provider system 148, and remittance network system 150, can be incorporated into a single computing system, or incorporated into multiple computing systems.

In some instances, transaction system 130 may be associated with, or operated by, a financial institution that issues one or more accounts held by corresponding customers, such an account held by user 101 and capable of funding remittance transactions initiated using any of the exemplary processes described herein. Examples of these accounts include, but are not limited to, a deposit account (e.g., a transaction account, a checking account, etc.), a savings account, a brokerage or investment account, a credit card account, or a line of credit issued by the financial institution and held by the one or more corresponding customers.

As described herein, transaction system 130 may perform operations that, in conjunction with data provider system 148 and remittance network system 150, dynamically provision and initiate exchanges of data based on an analysis of monitored and aggregated contextual data. In some instances, the exchanges of data may facilitate an initiation, execution, and settlement of one or more remittance transactions, and each of the remittance transactions may correspond to a cross-border electronic transfer of funds between a source account held by user 101 (e.g., a deposit account issued by the financial institution and denominated in Canadian dollars) and a destination account denominated in a foreign currency, such as Indian rupees or Thai baht.

In some instances, the monitored and aggregated contextual data may include, but is not limited to: (i) exchange-rate data that characterizes a current rate of exchange between various currencies (and a corresponding period of validity for that current rat); (ii) transaction data that identifies and characterizes prior remittance transactions initiated on behalf of one or more customers (e.g., user 101) during that prior temporal interval; and (ii) account data that identifies and characterizes accounts held by the one or more users and available to fund remittance transactions. Further, and based on application of one or more deterministic or stochastic statistical algorithms, adaptive classification models, machine learning algorithms or processes, or artificial neural network models to portions of the monitored and aggregated contextual data, transaction system 130 may determine parameter values characterizing a candidate remittance transaction capable of initiation by user 101 during a corresponding temporal interval, and may compute a value, e.g., a propensity score, indicative of a likelihood that user 101 will initiate candidate remittance transaction in accordance with the parameter values during the temporal interval.

When the computed propensity score is consistent with an at least one alert criterion, transaction system 130 may perform operations that generate and transmit, across network 120 via a secure communications channel, alert data to a network-connected device associated with, or operated by, the corresponding customer, e.g., client device 102 operated by user 101. As described herein, the alert data may include additional information that instructs an application program executed by the client device, such as remittance application 108, a web browser, or a messaging application, to generate and present, within a corresponding interface, a representation of the alert data automatically and without input from user 101.

In additional instances, transaction system 130 may perform operations that provision the candidate remittance transaction, and the parameter values and temporal window, to an account held by user 101 and capable of funding the candidate remittance transaction. Based on request data received from client device 102 across network 120, transaction system 130 may also perform operations that, in conjunction with remittance network system 150, initiate, execute, and settle the remittance transaction in accordance with the provisioned parameter values. In other instances, and as described herein, transaction system 130 may perform additional, or alternate, operations that, in conjunction with remittance network system 150, automatically initiate, execute, and settle a pre-approved remittance transaction without intervention from user 101.

To facilitate a performance of these exemplary processes, transaction system 130 may maintain, within one or more tangible, non-transitory memories, an exchange rate database 132, a customer account database 134, and a transaction database 156. By way of example, exchange rate database 132 may include data records that identify and characterize a current rate of exchange between various source and destination currencies, and a time evolution of these exchanges rates over a prior temporal interval, such as six months. In some instances, transaction system 130 may receive portions of the data records of exchange rate database 132 from one or more external computing systems, such as data provider system 148, at predetermined temporal intervals (e.g., via a “push” operation), or in response to a corresponding programmatic query generated by transaction system 130 (e.g., a “pull” operation).

Further, and for a particular pair of source and destination currencies, the data records of exchange rate database 132 may include identifiers of the source currency the destination currency, a currently quoted rate of exchange, and corresponding temporal data (e.g., a quotation date of Aug. 1, 2018 and a quotation time of 1:00 a.m.). In other instances, the data records of exchange rate database 132 may also include a period of validity associated with the quoted exchange rate, such as, but not limited to, fifteen minutes, thirty minutes, or sixty minutes.

Customer account database 134 may include data records that identify and characterize one or more accounts held by customers of transaction system 130, e.g., user 101. For example, and for each of the customers, the data records of customer database 132 may include a corresponding customer identifier (e.g., an alphanumeric login credential assigned to user 101 by transaction system 130) and data that uniquely identifies one or more devices associated with or operated by the customer (e.g., a unique device identifier, such as an IP address, a MAC address, a mobile telephone number, etc., that identifies client device 102).

Further, the data records of customer account database 134 may also link each customer identifier (and in some instances, the corresponding unique device identifier) to corresponding elements of account data 134A that identify and characterize one or more accounts available to fund remittance transactions initiated by transaction system 130. Examples of these available accounts include, but are not limited to, a deposit account (e.g., a transaction account, a checking account, etc.), a savings account, a brokerage or investment account, a credit card account, or a line of credit. For example, and for a corresponding user, such as user 101, account data 134A may include, but is not limited to, an identifier of each account held by user 101, along with tokenized (or actual) account data associated with each account, and data characterizing a current status of each account (e.g., a current balance, amount of available credit, an indicator of a delinquency, etc.).

Customer account database 134 may also maintain profile data 134B that characterizes each of the users of transaction system 130, such as user 101. By way of example, profile data 134B may include, but are not limited to, a full name of each of the users and contact information associated with each user, such as, but not limited to, a mailing address, a mobile number, an email address, and/or an identifier within one or more messaging applications. In other examples, profile data 134B may include, for each user, preference data characterizing one or more preferences for receiving notifications or alerts generated and transmitted by transaction system 130 (e.g., via client device 102 by a digital interface generated by executed remittance application 108, an executed web browser, or an executed messaging application, via telephone, etc.) and further, preferences for funding remittance transactions initiated by transaction system 130. Further, the data records of customer account database 134 may link user-specific portions of profile data 134B to corresponding one of user or device identifiers described herein.

In some instances, customer account database 134 may also include provisioned transaction data 134C, which identifies and characterizes one or more candidate remittance transactions provisioned to accounts held by users of transaction system 130, such as user 101. As described herein, these accounts (e.g., as specified within a corresponding portion of profile data 134B) may be capable of funding remittance transactions initiated by corresponding users, and provisioned transaction data 134C may include the parameter values and temporal window associated with each of the provisioned remittance transactions. In some instances, the data records of customer database 132 may link portions of provisioned transaction data 134C to corresponding ones of the unique user or device identifiers and further, to corresponding portions of account data 134A and profile data 134B.

Transaction database 136 may include data records that identify and characterize one or more remittance transactions initiated by, or on behalf of, one or more users of transaction system 130 during prior temporal intervals. For example, and for a corresponding one of the initiated remittance transactions, the data records of transaction database 136 may include, but are not limited to: a unique transaction identifier; data that identifies the initiating user or device (e.g., the login credential of user 101 or the device identifier of client device 102); a transaction time or date that; information identifying a recipient of, or a destination associated with, the initiated remittance transaction (e.g., a destination account associated with a recipient or a location of the recipient, such as Bangalore, India); an identifier of a source currency and a remitted amount of source currency; and an identifier of a destination currency; and an amount of destination currency received at the destination. The disclosed embodiments are, however, not limited these examples of identifying and characterizing data, and in other instances, the data records of transaction database 136 may maintain any additional or alternate information appropriate to one or more of the initiated remittance transactions.

Further, as illustrated in FIG. 1, transaction system 130 may also maintain, within the one or more tangible, non-transitory memories, one or more executable application programs 138, such as predictive engine 140, transaction provisioning engine 142, and remittance engine 144. For example, when executed by transaction system 130, predictive engine 140 may apply one or more deterministic or stochastic statistical algorithms, adaptive classification models, machine learning algorithms, or artificial neural network models to data records extracted from exchange rate database 132, customer account database 134, and transaction database 136. In some instances, the one or more deterministic or stochastic statistical algorithms, adaptive classification models, machine learning algorithms, or artificial neural network models may collectively establish, or may be implemented by, an adaptive propensity model.

Further, and based on the application of the adaptive propensity model to the extracted data records, executed predictive engine 140 may perform any of the exemplary processes described herein to determine parameter values that characterize one or more candidate remittance transaction capable of initiation by, or on behalf of, corresponding users during a future temporal interval, and to compute a value, e.g., a propensity score, for each of the candidate remittance transactions. In some instances, as described herein, the computed propensity score for a candidate remittance transaction may be indicative of a likelihood that a corresponding user, e.g., user 101, will initiate a remittance transaction in accordance with corresponding ones of the determined parameter value during the temporal interval. Further, and as described herein, the data records of transaction database 136 may be updated dynamically to reflect newly initiated remittance transactions, and one or more of the exemplary deterministic or stochastic statistical algorithms, adaptive classification models, machine learning algorithms or processors, or artificial neural network models may be adaptively improved using, or trained against, portions of transaction database 136.

Further, and upon execution by transaction system 130, transaction provisioning engine 142 may perform any of the exemplary processes described herein to provision a remittance transaction, and the determined parameter values and future temporal window, to an account held by a corresponding user of transaction system 130, such as user 101. By way of example, and as described herein, executed transaction provisioning engine 142 may generate and store, within one or more tangible, non-transitory memories (e.g., within a portion of provisioned transaction data 134C), provisioning information for the candidate remittance transaction that includes the determined parameter values, and that associates the determined parameter values with the account available to fund the candidate remittance transaction.

Further, when executed by transaction system 130, remittance engine 144 may perform any of the exemplary processes described herein to initiate, in conjunction with remittance network system 150, one or more of the candidate remittance transactions in accordance with corresponding ones of the candidate parameter values and during a corresponding temporal window. Further, in some instances, executed remittance engine 144 may initiate the candidate remittance transaction in response to additional user input received from a corresponding client device (e.g., input from user 101 via client device 102, which verifies the candidate parameter values), and additionally, or alternatively, automatically in response to a determination that the user pre-approved an initiation of the candidate remittance transaction (e.g., based on pre-approval data maintained locally by transaction system 130).

Referring back to FIG. 1, data provider system 148 may perform operations that provide, to transaction system 130 across network 120, data that populates all or a portion of exchange rate database 132 and in some instances, all or a portion of customer account database 134 or transaction database 136. For example, data provider system 148 may be operated by, or may be associated with, an exchange supporting trades in foreign currency, a financial reporter service, a news organization, a financial institution, or a remittance service provider (RSP) that distributed remitted funds in a destination currency to a recipient.

Remittance network system 150 may perform any of the exemplary processes described herein to execute and settle one or more remittance transactions initiated by transaction system 130 in accordance with established values of corresponding transaction parameters. The performance of these exemplary processes by remittance network system 150, in conjunction with transaction system 130, may debit a remitted amount of funds in a source currency from an account of an initiating user (e.g., a deposit account held by user 101 and issued by the financial institution operated by transaction system 130), and further, may credit a corresponding amount of funds in a destination currency into a destination account. The destination account may, for example, held by a recipient and issued by financial institution located in a foreign country, or alternatively, may be held by or associated with a corresponding RSP, which may distribute an amount of currency consistent with the destination amount and denominated in the destination currency to the recipient. In some instances, remittance network system 150 may be associated with, or operated by, one or more remittance service providers (RSPs), one or more financial institutions, one or more exchanges for foreign currency, or one or more payment networks.
II. Exemplary Computer-Implemented Processes for Automatically Provisioning and Initiating Data Exchanges Based on Aggregated Contextual Information

In some embodiments, a network-connected computing system operating within environment 100, such as transaction system 130, may perform operations that obtain and aggregate elements of contextual information that identify one or more exchanges of data initiated during a prior temporal interval, and additionally, or alternatively, that identify a current value of one or more parameters that characterize these initiated data exchanges and a status of one or more accounts associated with, or involved in, corresponding ones of the initiated data exchanges. As described herein, transaction system 130 may also maintain a predictive engine, such as predictive engine 140 of FIG. 1, that, when executed by transaction system 130, applies an adaptive propensity model to portions of the aggregated contextual information.

For example, and as described herein, the adaptive propensity model may incorporate, or may be established by, one or more deterministic or stochastic statistical algorithms, adaptive classification models, machine learning algorithms, adaptive processes, or artificial neural network models. Based on an application of the adaptive propensity model, and the deterministic or stochastic statistical algorithms, adaptive classification models, machine learning algorithms, adaptive processes, or artificial neural network models described herein, executed predictive engine 140 may determine values of parameters that characterize one or more exchange of data capable of initiation during a future temporal interval (e.g., one or more “candidate” data exchanges), and compute a value (e.g., a propensity score) for each of the candidate data exchanges. As described herein, the propensity score computed for a corresponding one of the candidate data exchanges may be indicative of a likelihood that a corresponding user of transaction system 130, e.g., user 101 of FIG. 1, would initiate that candidate data exchange in accordance with corresponding ones of the determined parameter values during the future temporal interval.

In some exemplary embodiments, one or more of the candidate data exchanges may correspond to a candidate remittance transaction, which, if initiated and executed, would facilitate a cross-border electronic transfer of funds between a source account held by user 101 (e.g., an issued by the financial institution that operated transaction system 130 and denominated in a source currency) and a destination account denominated in a destination currency, e.g., a foreign currency. Further, and to determine parameter values that characterize each candidate remittance transaction, and to compute a propensity score associated with each candidate remittance transaction, transaction system 130 may obtain and aggregate elements of contextual information that include, but are not limited to, transaction data identifying one or more prior remittance transactions initiated by users of transaction system 130, exchange rate data that characterizes one or more current, quoted exchange rates for remittance transactions, and account data that specifies a status of one or more accounts held by the users of transaction system 130 and available to fund initiated remittance transactions.

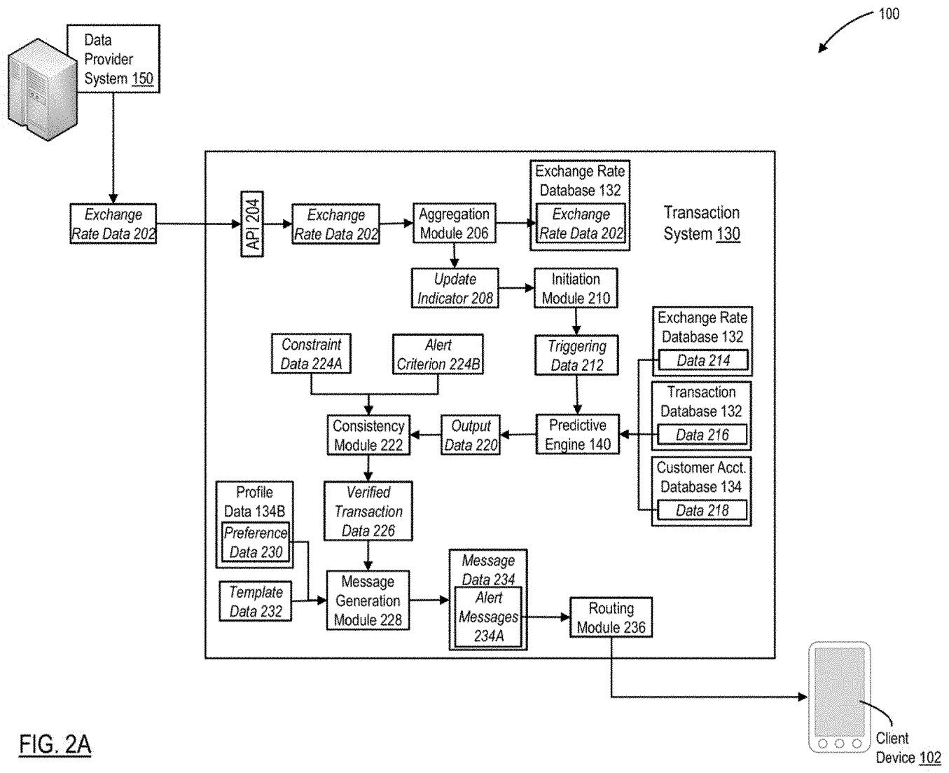

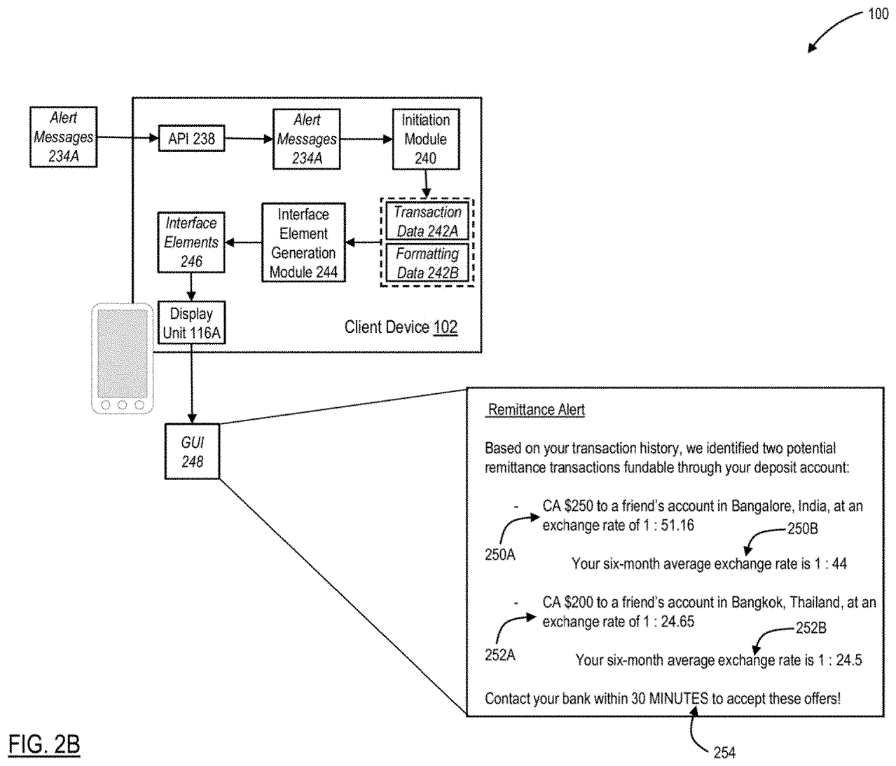

Transaction system 130 may maintain portions of the obtained transaction data, the account data, and the exchange rate data within one or more tangible, non-transitory memories, such as within exchange rate database 132, customer account database 134, and transaction database 136 of FIG. 1. For example, portions of this locally maintained exchange rate, account, and transaction data may be generated locally by transaction system 130 (e.g., based on operations performed by one or more executed application programs, such as transaction provisioning engine 142 or remittance engine 144), or may be received from client device 102 across network 120 through a secure, programmatic interface, e.g., during the initial registration processes described herein. In other instances, illustrated in FIG. 2A, transaction system 130 may obtain all, or a portion, of the exchange rate data, account data, or transaction data from one or more external, network-connected computing systems in communication with transaction system 130 through a secure, programmatic interface, such as data provider system 148 of FIG. 1.

By way of example, and referring to FIG. 2A, data provider system 148 may perform operations that provide, to transaction system 130 across network 120, exchange rate data 202 that populates all or a portion of exchange rate database 132. Exchange rate data 202 may, for example, include structured or unstructured data records that identify and characterize a plurality of exchange rates quoted for remittance transactions initiated, executed, and settled using any of the exemplary processes described above. For example, and for each of the quoted exchange rates, the data records of exchange rate database 132 may specify identifiers of the corresponding source currency and destination currency, the quoted exchange rate, and temporal data associated with the exchange rate, such time or date associated with quoted exchange rate or a period of validity for the quoted exchange rate.

A secure programmatic interface of transaction system 130, e.g., application programming interface (API) 204, may receive and route exchange rate data 202 to an aggregation module 206 executed by transaction system 130. API 204 may be associated with or established by aggregation module 206, and may facilitate secure, module-to-module communications across network 120 between aggregation module 206 and one or more application programs or modules executed by data provider system 148. For example, transaction system 130 may subscribe to a data feed published by data provider system 148, and may receive exchange rate data 202, which includes published data characterizing current or updated rates of exchange, through API 204 at regular, predetermined intervals, such as, but not limited to, fifteen-minute intervals, thirty-minute intervals, or hourly intervals (e.g., via a “push” operation). In other examples, transaction system 130 may receive exchange rate data 202 from data provider system 148 in response to a request generated and programmatically transmitted to data provider system 148, e.g., through a “pull” operation.

As illustrated in FIG. 2A, API 204 may route exchange rate data 202 to aggregation module 206 of transaction system 130. In some instances, aggregation module 206 may parse exchange rate data 202 and perform operations that populate, or update, the data records of exchange rate database 132 to include all, or a portion, of exchange rate data 202. For example, aggregation module 206 may apply one or more database management processes to the structured or unstructured data records of exchange rate database 132 and to exchange rate data 202, such as, but not limited to, extract, transform, and load (ETL) processes that combine, merge, or update structured and unstructured data records of exchange rate data 202 and exchange rate database 132 in accordance with certain commonly referenced primary keys, such as unique user identifiers, unique device identifiers, or identifiers of source or destination currencies.

The population of the data records of exchange rate database 132 with corresponding portions of exchange rate data may, in some examples, update the data records of exchange rate database 132 to reference newly quoted, and currently valid, exchange rates available for remittance transactions initiated using any of the exemplary processes described herein. Further, aggregation module 206 may generate an indicator, e.g., update indicator 208, that confirms and reflect the newly populated or updated data records of exchange rate database 132, and aggregation module 206 may provide update indicator 208 as an input to an initiation module 210, which may perform any of the exemplary processes described herein to trigger an application of an adaptive propensity module to corresponding portions of exchange rate database 132, customer account database 134, and transaction database 136.

In some instances, as described herein, aggregation module 206 may perform operations that update portions of exchange rate database 132 based on corresponding portions of exchange rate data 202 received from data provider system 148, e.g., through API 204. In other instances, and consistent with the disclosed embodiments, data provider system 148 may also provision transaction system 130 with additional, or alternate, elements of updated account data or updated transaction data, e.g., through API 204 using any a corresponding push or pull operation. Aggregation module 206 may, for instance, perform any of the exemplary processes described herein to update or populate one or more of customer account database 134 (e.g., portions of account data 134A) and transaction database 136 to include and reflect corresponding ones of the newly updated account or transaction data, and aggregation module 206 may generate an additional indicator of the newly populated or updated portions of customer account database 134 and/or transaction database 136

Referring back to FIG. 2A, initiation module 210 may receive update indicator 208 and determine whether to execute predictive engine 140, which may perform any of the exemplary processes described herein to apply the adaptive propensity model (e.g., one or more deterministic or stochastic statistical algorithms, adaptive classification models, machine learning algorithms, adaptive processes, or artificial neural network models) to corresponding portions of exchange rate database 132, customer account database 134, and transaction database 136 and additionally, or alternatively, to elements of data derived or computed from corresponding portions of exchange rate database 132, customer account database 134. In one instance, initiation module 210 may be configured to execute predictive engine 140 in response to a receipt of data, e.g., update indicator 208, identifying a newly completed update to exchange rate database 132, customer account database 134, or transaction database 136.

In other instances, and consistent with the disclosed embodiments, initiation module 210 may be configured to execute predictive engine 140 in accordance with a predetermined temporal schedule, e.g., at fifteen-minute intervals, thirty-minute intervals, or hourly intervals. The predetermined schedule may, for example, be defined by, or reflect, one or more user-defined preferences for receiving alerts or notifications generated by transaction system 130 (e.g., as maintained within profile data 134B of customer account database 134) and additionally, or alternatively, one or more protocols associated with remittance network system 150. Examples of these protocols include, but are not limited to, a maximum or a minimum temporal delay between initiated remittance transaction, or a maximum number of remittance transactions capable of initiation by, or on behalf of, a corresponding user of transaction system 130 within a particular temporal interval. In other instances, initiation module 210 may also be configured to execute predictive engine 140 in response to a determination that a delay between a current time and a time associated with a prior execution of predictive engine 140 exceeds a threshold value.

For example, if initiation module 210 were to decline to initiate predictive engine 140, initiation module 210 may discard received update indicator 208. Initiation module 210 may perform additional operation that await an execution of predictive engine 140 in accordance with the predetermined schedule or in accordance with any additional or alternate triggering event.

Alternatively, initiation module 210 may perform operations that cause transaction system 130 to execute predictive engine 140, and may provide, as an input to predictive engine 140, triggering data 212 that causes executed predictive engine to extract one or more data records from exchange rate database 132, customer account database 134, and transaction database 136. In some instances, and as described herein, predictive engine 140 may apply the adaptive propensity model (e.g., the one or more deterministic or stochastic statistical algorithms, adaptive classification models, machine learning algorithms, adaptive processes, or artificial neural network models) to corresponding potions of the extracted data records, and additionally, or alternatively, to additional input data derived or computed from the extracted data records.

Based on the application of the adaptive propensity model, executed predictive engine 140 may perform any of the exemplary processes described herein to determine values of parameters that characterize one or more exchanges of data capable of initiation by, or on behalf of, corresponding users of transaction system 130 (e.g., one of more candidate data exchanges), and to compute propensity scores for each of the candidate data exchanges. As described herein, the propensity score for a corresponding one of the candidate data exchanges may be indicative of a likelihood that a user, such as user 101, would initiate the candidate data exchange in accordance with its parameter values during a corresponding future temporal interval.

Referring back to FIG. 2A, executed predictive engine 140 may receive triggering data 212, and may perform operations that access data records maintained within exchange rate database 132. In some instances, executed predictive engine 140 may parse the data records of exchange rate database 132 to identify, and extract, one or more exchange-rate data records 214 that characterize quoted exchange rates that are currently valid for remittance transactions. As described herein, each of extracted data records 214 may specify, respectively, identifiers of the corresponding source currency and destination currency, the quoted exchange rate of exchange, and temporal data associated with the exchange rate.

Further, and response to the receipt of triggering data 212, executed predictive engine 140 may perform additional operations that access data records maintained within transaction database 136, and may identify and extract transaction data records 216 that identify corresponding remittance transactions previously initiated by, or on behalf of, corresponding users of transaction system 130, such as user 101. In some instances, and as described herein, each of the transaction data records 216 may include, but is not limited to, a unique transaction identifier, data that identifies the corresponding user or a device associated with that corresponding user (e.g., the unique user identifier of user 101 or the unique device identifier of client device 102), a transaction time or date that characterizes the initiated remittance transaction, information identifying a recipient of, or a destination associated with, the initiated remittance transaction, an identifier of a source currency and an amount of source currency remitted to the destination, and an identifier of a destination currency and an amount of destination currency received at the destination.

In further instances, executed predictive engine 140 may parse transaction data records 216 to identify, and extract, the user and/or the device identifier from each of transaction data records 216. Executed predictive engine 140 may perform additional operations that access customer account database 134, and identify, within account data 134A, one or more account data records 218 that include or reference corresponding ones of the extracted user and/or device identifiers. For example, each of extracted account data records 218 may include, but is not limited to, the corresponding user and/or device identifier, an identifier of a corresponding account, tokenized (or actual) account data associated with the corresponding account, and data characterizing a current status of each of the account (e.g., a current balance, amount of available credit, an indicator of a delinquency, etc.).

In some instances, based on an application of the adaptive propensity model to portions of exchange-rate data records 214, transaction data records 216, and account data records 218, executed predictive engine 140 may perform operations that determine parameter values characterizing one or more candidate remittance transactions capable of initiation by, or on behalf of, users of transaction system 130 during a corresponding future temporal interval. By way of example, the parameter values that characterize each of the candidate remittance transaction can include, but are not limited to, identifiers of a source and a destination currency, a currently quoted rate of exchange between the source and destination currencies, a remitted amount of the source currency, and data identifying a destination account, such as a tokenized (or actual) account number of a destination account held by a recipient, or by a remittance service provider (RSP) that distributes units of the destination currency to the recipient. Additionally, in some examples, the parameter values that characterize each of the candidate remittance transactions may be linked to a corresponding one of the unique user identifiers and/or the unique device identifiers.

Further, and as described herein, the future temporal window assigned to each of the candidate remittance transactions (e.g., as determined by the applied, adaptive propensity model) may correspond to a period of validity associated with a corresponding one of the currently quoted exchange rates, such as, but not limited to, a fifteen-minute interval, a thirty-minute interval, or a sixty-minute interval. In some instances, executed predictive engine 140 may further limit the future temporal window assigned to each of the candidate remittance transactions based on one or more remittance protocols implemented by transaction system 130, such as those that establish a minimum time period or a maximum time period between successively initiated remittance transactions.

In some instances, the adaptive propensity model may include, or may be established by, deterministic or stochastic statistical algorithms or processes that, when applied to portions of exchange-rate data records 214, transaction data records 216, and account data records 218 by executed predictive engine 140, facilitate a determination of the parameter values that characterize one or more of the candidate remittance transactions. Examples of these deterministic or stochastic statistical algorithms or processes include, but are not limited to, a linear or non-linear regression algorithm, a multiple regression algorithm, a least absolute selection shrinkage operator (LASSO) regression algorithm, a logistic regression algorithm, or a supervised machine learning algorithm, such as a multivariate regression algorithm or a support vector machine (SVM) model.

The adaptive propensity model may also include, or may be established by, one or more adaptive classification models that, when applied to portions of exchange-rate data records 214, transaction data records 216, and account data records 218 by executed predictive engine 140, facilitate the determination of the parameter values that characterize one or more of the candidate remittance transactions. Examples of these adaptive classification models include, but are not limited to, a multinomial logistic regression model, an SVM model, such as a least-squares SVM model, a quadratic classifier algorithm, a kernel estimation algorithm, such as a k-nearest neighbors (k-NN) algorithm, or an adaptive, neural network model.

In other instances, and consistent with the disclosed embodiments, the adaptive propensity model may also include, or may be established by, one or more machine learning algorithms or adaptive processes that, when applied to portions of exchange-rate data records 214, transaction data records 216, and account data records 218 by executed predictive engine 140, facilitate the determination of the parameter values that characterize one or more of the candidate remittance transactions. Examples of the one or more machine learning algorithms or adaptive processes include, but are not limited to, an association-rule algorithm (such as an Apriori algorithm, an Eclat algorithm, or an FP-growth algorithm), a clustering algorithm (such as a hierarchical clustering module, a k-means algorithm, or other statistical clustering algorithms), a collaborative filtering algorithm (such as a memory- or model-based algorithm), or an artificial intelligence algorithm (such as an artificial neural network).

The disclosed embodiments are, however, not limited to these exemplary deterministic or stochastic statistical algorithms or processes, adaptive classification models, machine learning algorithms, and adaptive processes, and in other instances, the adaptive propensity model may also include, or may be established by, any additional or alternate algorithm of process that, when applied to portions of exchange-rate data records 214, transaction data records 216, and account data records 218, or to values derived or computed from these data records, facilitate the determination of the parameter values that characterize one or more of the candidate remittance transactions. Further, and as described herein, one or more of these exemplary deterministic or stochastic statistical algorithms or processes, adaptive classification models, machine learning algorithms, and adaptive processes, may be trained against, and adaptively improved using, certain portions of provisioned transaction data 134C, which specifies provisioned parameter values of candidate remittance transaction, and one or more data records of transaction database 136, which identify parameter values of the initiated and executed ones of the candidate remittance transactions.

In additional exemplary embodiments, based on an application of the adaptive propensity model to portions of exchange-rate data records 214, transaction data records 216, and account data records 218, to additional parameter values derived or computed from portions of these data records, and additionally, or alternatively, to parameter values that characterize the candidate remittance transaction, executed predictive engine 140 may perform any of the exemplary processes described herein to compute a propensity score for each of the candidate remittance transactions. For example, and as described herein, the propensity score associated with a corresponding one of the candidate remittance transactions may be indicative of a likelihood that a user of transaction system 130, e.g., user 101, will initiate the candidate remittance transaction in accordance with the parameter values during the temporal interval. Further, in some instances, the computed propensity score for each of the candidate remittance transactions may represent a normalized, numerical value ranging from zero to unity, with a propensity score of zero being indicative of a minimal likelihood, and a propensity score of unity being indicative of a maximum likelihood.

In one instance, the adaptive propensity model, as described herein, may parameterize the propensity score for one or more of the candidate remittance transactions as a function of certain values extracted by executed predictive engine 140 from one or more of exchange-rate data records 214, transaction data records 216, and account data records 218. Examples of these extracted values include, but not limited to, currently quoted exchange rate, a prior remitted amount of source currency, or a current balance of an account available to fund initiated remittance transactions.

In other instances, the adaptive propensity model may parameterize the propensity score for one or more of the candidate remittance transactions as a function of additional values derived or computed from these extracted values. Examples of these derived or computed values include, but not limited to, an average time period between remittance transactions initiated by, or on behalf of a corresponding user (e.g., Δt_{AVG}), a time period between a current time and a most recent remittance transaction initiated by, or on behalf of the corresponding user (e.g., Δt_{N}), an average exchange rate for initiated remittance transactions involving a corresponding destination over a specified prior temporal interval, such as six months (e.g., R_{AVG,6 month}).

Additionally, or alternatively, the adaptive propensity model may parameterize the propensity score for one or more of the candidate remittance transactions as a function of certain combinations of the extracted value and the derived or computed values. For example, a corresponding one of the candidate remittance transactions may represent a remittance of CA $250 from a source account held by user 101 (e.g., a deposit account having a current balance of CA $3,325) to a destination account in Bangalore, India. The destination account may be denominated in Indian rupees, and the exchange rate between Canadian dollars and Indian rupees may be currently quoted as 1:52.16. In some instances, the adaptive propensity model can parameterize the propensity score this exemplary candidate remittance transaction by the following function:

P=β₀+β₁ (Δt_{AVG}−Δt_{N})+β₂ (R_{AVG,6 month}−R_{CURR})+β₃(V_{ACCT}−V_{R, AVG}),

where β₀, β₁, β₂, and β₃ represent coefficients of the linear combination. In some instances, these coefficients may be determined based on an application of one or more curve fitting algorithms or processes to previously computed values of propensity data, and underlying computed, extracted, or derived values of independent variables, e.g., as maintained within corresponding potions of one or more locally accessible, tangible, non-transitory memories (e.g., transaction database 136 of FIG. 1).

Further, and as described herein, Δt_{AVG} and Δt_{N} represent, respectively, the average time period between remittance transactions initiated by, or on behalf of, user 101 and the time period between the current time and the most recent remittance transaction initiated by, or on behalf of, user 101, R_{AVG,6 month} represents the average exchange rate between Canadian dollars and Indian rupees over the past six months, involving a corresponding destination over a specified prior temporal interval, such as six months, R_{CURR} represents the currently quoted exchange rate between Canadian dollars and Indian rupees (e.g., 1:52.16), V_{ACCT} represents a current balance of a funding account held by user 101 (e.g., the current balance of CA $3,325 within user 101's balance account), and V_{R, AVG} represents an average remittance amount associated with the initiated remittance transactions between user 101's deposit account and the destination account in Bangalore, India.

The disclosed embodiments are, however, not limited to propensity values computed in accordance with this exemplary linear combination of derived and extracted values. In other instances, and consistent with certain disclosed embodiments, executed predictive engine 140 may determine a propensity score for one or more of the candidate remittance transactions based on any addition, or alternate, linear or non-linear combination of extracted or derived variables, or based on an application of any of the deterministic or stochastic statistical algorithms or processes, adaptive classification models, or machine learning algorithms or processors described herein to portions of exchange-rate data records 214, transaction data records 216, and account data records 218.

Referring back to FIG. 2A, executed predictive engine 140 may perform additional operations that package the parameters values characterizing each of the candidate remittance transactions, along with additional data identifying corresponding ones of the computed propensity scores, within portions of output data 220. In some instances, output data 220 may also include data identifying a user that initiated each of the candidate remittance transactions (e.g., the unique, alphanumeric identifier of user 101 or the unique device identifier of user 101), and may link the identifying data to corresponding portions of the parameter values and to the associated propensity score. Executed predictive engine 140 may provide output data 220 as an input to a consistency module 222 of transaction system 130, which may perform any of the exemplary processes described herein to confirm, for each of the candidate remittance transactions, that the corresponding propensity score is consistent with at least one alert criterion and further, that the corresponding parameter values are consistent transactional constraints.

Consistency module 222 may receive output data 220, which identifies and characterizes each of the candidate remittance transactions, and which identifies the propensity score associated with each of the candidate remittance transactions. In some instances, consistency module 222 may perform operations that access one or more tangible, non-transitory memories, and obtain data 224A that identifies one or more constraints imposed on the parameter values that characterize each of the candidate remittance transactions, and further, data 224B that identifies at least one alert criterion application to the associated propensity scores.

By way of example, the one or more constraints may include, but are not limited to, a rate-specific constraint (e.g., a maximum exchange rate for a candidate remittance transaction), an account-specific constraint (e.g., a minimum balance associated with an account that funds a candidate remittance transaction), and a transaction-specific constraint (e.g., a maximum time between successive initiated remittance transaction or a maximum remittance amount imposed by a corresponding remittance network). In some instances, a user of transaction system 130, such as user 101, may specify one or more of the rate-specific constraints (e.g., a user-specified limit on the quoted exchange rate) or the account-specific constraints (e.g., a user-specified minimum balance within a deposit account) during an initial registration process, e.g., via a digital interface presented to user 101 via client device 102. Additionally, or alternatively, the account-specific constraint may be established by a financial institution that issues an account to user 101, and may represent, among other things, a minimum balance imposed by the financial institution to avoid fees on user 101's deposit account. Further, in some instances, one or more of the rate-, account-, or transaction-specific constraints may vary over time or seasonally, e.g., due to a periodicity of pay periods, variations in seasonal work, etc.

By way of example, consistency module 222 may perform operations that apply the rate-, account-, and/or transaction-specific constraints to the parameter values that characterize each of the candidate remittance transactions specified within output data 220, and may identify a subset of those candidate remittance transactions characterized by parameter values that are consistent with each of the rate-, account-, and/or transaction-specific constraints. Further, consistency module 222 may perform additional operations that identify one or more of the identified subset of candidate remittance transactions that are consistent with the at least one alert criteria and as such, are consistent with the at least one alert criterion.

The at least one alert criterion may, for example, specify a threshold propensity value, and a corresponding one of the subset of candidate remittance transactions may satisfy the at least one criterion when the associated propensity value exceeds the threshold propensity value. In other instances, the at least one alert criterion may specify a threshold number of consistent remittance transactions, and consistency module 222 may perform operations that rank the subset of the candidate remittance transactions in accordance with the associated propensity values, and determine that threshold number of highest-ranking candidate remittance transactions satisfy the at least one alert criterion. The disclosed embodiments are, however, not limited to these exemplary alert criteria and in other instances, data 224B may specify any additional, or alternate, alert criterion appropriate to the parameter values characterizing each of the candidate remittance transactions.

In some instances, consistency module 222 may perform operations that identify one or more of the subset of the candidate remittance transactions (e.g., “consistent” remittance transaction) having parameter values that are consistent with each of the imposed rate-, account-, or transaction-specific constraints, and further, that are associated with propensity values that satisfy the at least one alert criterion. Consistency module 222 may package the parameter values that characterize each of the identified candidate remittance transactions, along with data identifying the corresponding users (e.g., the unique alphanumeric identifier of user 101 and/or the unique device identifier of client device 102), into portions of verified transaction data 226, which consistency module 222 may provide as an input to a message generation module 228 of transaction system 130.

Message generation module 228 may receive verified transaction data 226, which may specify parameter values of the candidate remittance transactions that are consistent with the at least one alert criterion and each of the imposed constraints. In some instances, and as described herein, message generation module 228 may perform operations that generate, for each of the corresponding users, one or more alert messages identifying and characterizing corresponding ones of the verified remittance transactions in accordance with one or more alert and notification preferences of the corresponding users. For example, and as described herein, the alert and notification preferences may specify, for each of the users of transaction system 130, one or more preferred modes communication for receiving generated alerts or notification, such as, but not limited to, a preference for receiving alerts or notifications via email, via text message (e.g., by one or more executed messaging applications, such as WhatsApp™), via browser notification (e.g., by a notification delivered to, and presented within, an executed web browser), or via application-specific notification (e.g., within a digital interface generated by executed remittance application 108).

In other examples, the alert and notification preferences may also specify, for one or more users of transaction system 130, a content-based preference for the received alerts or notifications, such as, but not limited to, a preference to receive alerts or notifications in text form without graphics, or in HTML form. The disclosed embodiments are, however, not limited these exemplary alert and notification preferences, and other instances, the alert and notification preferences may include any additional or alternate communication or content preferences that would be appropriate to transaction system 130 and to the network-connected devices operated by the users of transaction system 130, such as client device 102.

In some instances, message generation module 228 may access customer account database 134, and identify and extract, from profile data 1346, one or more elements of preference data 230, which identifies the alert and notification preferences for each user of transaction system 130. For instance, each of the extracted elements of preference data 230 may associated with, and linked to, the user or device identifier associated with a corresponding user, such as user 101. As described herein, the user and/or device identifier may also be linked to one or more of the remittance transactions identified within verified transaction data 226.

For example, verified transaction data 226 may link the login credential of user 101 (or the device identifier of client device 102) to a first one of the verified remittance transactions, such as a first candidate remittance of CA $250 to a destination account denominated in Indian rupees and located in Bangalore, India. Further, in some instances, the login credential of user 101 (or the device identifier of client device 102) may also be linked to one or more additional candidate remittance transactions within verified transaction data 226, such as, but not limited to, a second candidate remittance of CA $200 to a destination account denominated in Thai baht and located in Bangkok, Thailand. Message generation module 228 may also extract an element of preference data 230 that includes or references the login credential of user 101 (or the device identifier of client device 102), and that specifies a preference of user 101 to receive alerts via text message (e.g., by one or more executed messaging applications, such as WhatsApp™) and via application-specific notification (e.g., within a digital interface generated by executed remittance application 108).

Referring back to FIG. 2A, message generation module 228 may perform operations that generate the one or more alert messages for each of the users specified within verified transaction data 226 in accordance with corresponding elements of preference data 230. In some instances, the alert messages generated for a corresponding one of the users, such as user 101, may include an amount or a type of transaction data that is consistent with a content-based preference specified within preference data 230, such as, but not limited to, data that specifies the parameter values for the first or second candidate remittance transactions identified within verified transaction data 226. Further, and as described herein, each of the alert messages generated for a corresponding user, such as user 101, may also be consistent with a preferred mode of communication specified within preference data 230.

In some instances, to generate alert messages consistent with the alert and notification preferences, message generation module 228 may access one or more tangible, non-transitory memories and extract template data 232, specifies a format, content, or a layout for alert messages generated in accordance with each of the alert and notification preferences. Message generation module 228 may select portions of template data 232 that are consistent with the alert and notification preferences of each user of transaction system 130 identified within verified transaction data 226, and may perform operations that generate, for each of the users, one or more alert messages consistent with the selected portions of template data 232.

Message generation module 228 may package the alert messages, on a user-by-user basis, into corresponding portions of message data 234. Message generation module 228 may also perform operations that include within message data 234 the login credential and the unique device identifier (e.g., the IP or MAC address) associated with each of the users, and link the login credential and the unique device identifier to corresponding ones of the generated alert messages. In some instances, message generation module 228 may provide message data 234 as an input to a routing module 236 of transaction system 130.

Routing module 236 may receive message data 234 from message generation module 228, and may parse message data 234 to extract discrete groups of generated alert messages associated with corresponding user identifiers and corresponding device identifiers. For example, routing module 236 may identity and extract, from message data 234, alert messages 234A that are linked to the alphanumeric login credential of user 101 and further, that are linked the device identifier of client device 102 (e.g., the assigned IP or MAC address). In some instances, alert messages 234A may include, but are not limited to, two discrete alert messages capable of delivery and presentation via text-message (e.g., through a messaging application executed by client device 102) and via application-specific notification (e.g., through a remittance application executed by client device 102). Routing module 236 may perform operations that transmit alert messages 234A across network 120 to the unique network address of client device 102 (e.g., the IP or MAC address) using any appropriate communications protocol.

Further, may also perform operations that transmit each additional, or alternate, group of extracted alert messages across network 120 to a corresponding network address of a network-connected device using any of appropriate communications protocols. Further, and by way of example, one or more of the user-specified alert and notification preferences may identify a preference to receive voice-based notifications generated and transmitted across network 120. In some instances (not illustrated in FIG. 2A), transaction system 130 may execute one or more applications, such as a text-to-speech (TTS) engine, that converts textual alert data included within one or more of the generated alert messages into corresponding synthesized speech. Transaction system 130 may perform operations that transmit the synthesized speech across network 120 to a corresponding network-connected device using any of the exemplary telecommunications protocols described herein, such as, but not limited to, GSM® technologies, CDMA technologies, GPRS® technologies, or LTE® technologies.

The network-connected devices may receive the transmitted alert messages through one or more secure, programmatic interfaces, such as an application programming interface (API), and may perform operations that execute an application program capable of processing and rendering each of the alert messages for presentation within a corresponding digital interface. By way of example, each of the alert messages may include an application identifier that uniquely identifies a corresponding executable application program capable of processing that alert message (e.g., within a header portion of the alert message), and examples of the executable application programs include, but are not limited to, an email application (e.g., Outlook™, etc.), a messaging application (e.g., WhatsApp™), a web browser, or an executable application associated with transaction system 130.

By way of example, and referring to FIG. 2B, a secure programmatic interface of client device 102, e.g., an application programming interface (API) 238, may receive and route alert messages 234A to an initiation module 240 of client device 102. API 238 may be associated with or established by initiation module 240, and may facilitate secure, module-to-module communications across network 120 between initiation module 240 and routing module 236 of transaction system 130. In some instances, initiation module 240 may parse alert messages 234A to identify one or more application programs that, when executed by client device 102, perform operations that render corresponding ones of alert messages 234A for presentation within a corresponding digital interface. Initiation module 240 may identify each of the one or more application programs based on an analysis of an application identifier included within each of alert messages 234A (e.g., within a header portion).

For example, and as described herein alert messages 234A may include, but are not limited to, two discrete alert messages capable of delivery and presentation via text-message (e.g., through a messaging application, such as WhatsApp™) and via application-specific notification (e.g., through executed remittance application 108). In some instances, and based on the application identifiers, initiation module 240 may perform operations that cause client device 102 to execute the messaging application and remittance application 108, each of which perform additional operations that render a corresponding one of the discrete alert messages for presentation within a corresponding digital interface. Further, although certain of the exemplary rendering and presentation processes described in reference to FIG. 2B are performed by a single executed application program (e.g., the executed messaging application or executed remittance application 108), one or more additional, or alternate, executed application programs may perform any of the exemplary rendering and presentation processes described herein to render and present a corresponding one of alert messages 234A within a corresponding digital interface.

Referring back to FIG. 2B, and upon execution of the message application or remittance application 108, initiation module 240 may parse alert messages 234A and extract parameter data characterizing one or more candidate remittance transactions identified within alert messages 234A (e.g., a corresponding one of the application-specific alert messages included within alert messages 234A). In some instances, alert messages 234A may identify and characterize a single candidate remittance transaction capable of initiation by user 101 within a corresponding temporal interval (e.g., the first candidate remittance of CA $250 to a destination account denominated in Indian rupees and located in Bangalore, India). In other instances, and consistent with the disclosed embodiments, alert messages 234A may identify and characterize multiple candidate remittance transactions capable of initiation by user 101 within the corresponding temporal interval (e.g., the first candidate remittance described herein and a second candidate remittance of CA $200 to a destination account denominated in Thai baht and located in Bangkok, Thailand).

Initiation module 240 may perform operations that extract, from portions of alert messages 234A, parameter values and the temporal window (and in some instances, additional contextual information) that characterize each of the candidate remittance transactions identified within alert messages 234A. For example, the parameter values for each of the candidate remittance transactions may include, but are not limited to, an identifier of a source currency (e.g., Canadian dollars) and a destination currency (e.g., Indian rupees or Thai baht), a remitted amount of the source currency (e.g., CA $250 or CA $200), a currently quoted exchange rate, an identifier of a source account capable of funding the remitted amount (e.g., a portion of an account number of user 101's deposit account), and an identifier of a destination account (e.g., a name of the recipient, a tokenized portion of the destination account, etc.).

The additional contextual information characterizing one or more of the candidate remittance transactions may include, but is not limited to, a running average of a corresponding exchange rate over a temporal interval (e.g., six months), an average time between initiation of remittance transactions involving the destination account, an average amount remitted to the destination account over the temporal interval, and a current balance of user 101's deposit account, e.g., which funds the remitted amount. In some instances, when presented to user 101 via the corresponding digital interface, may enable user 101 to characterize visually a level of conformity between the candidate remittance transaction and a history of remittance transactions involving the destination account. Further, the disclosed embodiments are not limited to these exemplary parameter values and examples of contextual information, and in other instances, initiation module 240 may extract any additional or alternate parameter values or contextual information appropriate to the candidate remittance transactions from corresponding portions of alert messages 234A.

Initiation module 240 may package the extracted parameter values, the extracted temporal window, and in some instances, the additional contextual information, into corresponding portions of transaction data 242A. Further, in some instances, initiation module 240 may also parse alert messages 234A to identify and extract formatting data 242B identifying and characterizing a formatting or a layout of a corresponding one of the alert messages (e.g., as specific to the executed messaging application or executed remittance application 108). Initiation module 240 may provide transaction data 242A and formatting data 242B as inputs to an interface element generation module 244 (e.g., associated with the executed messaging application or executed remittance application 108), and interface element generation module 244 may process corresponding portions of transaction data 242A and formatting data 242B to generate interface elements 246 representative of the parameter values, temporal window, or additional contextual information characterizing each of the candidate remittance transactions (and formatted in accordance with corresponding portions of formatting data 242B).

Interface element generation module 244 may route interface elements 246 to display unit 116A of client device 102, which renders interface elements 246 for presentation within a corresponding graphical user interface (GUI) 248. In some instances, GUI 248 may include presented interface elements 250A, which identify and characterize the first candidate remittance transaction (e.g., a remittance of CA $250 to a destination account denominated in Indian rupees and located in Bangalore, India), and presented interface elements 250B, which identifies additional contextual information associated with the first candidate remittance transaction (e.g., a six-month running average of the exchange rate between Canadian dollars and Indian rupees).

GUI 248 may also include presented interface elements 252A, which identify and characterize the second candidate remittance transaction (e.g., a remittance of CA $200 to a destination account denominated in Thai baht and located in Bangkok, Thailand), and presented interface elements 252B, which identifies additional contextual information associated with the second candidate remittance transaction (e.g., a six-month running average of the exchange rate between Canadian dollars and Thai baht). Further, GUI 248 may include additional presented interface elements 254, which prompt user 101 to content their financial institution within the corresponding temporal window, such as thirty minutes, to verify the parameter values and to request an initiation of one or more of the first or second candidate remittance transactions in accordance with portions of the verified parameter values.

For example, and in response to the presentation of GUI 248 on display unit 116A, user 101 may provide input to client device 102 (not illustrated in FIGS. 2A or 2B) that causes client device 102 to execute a web browser or an application program associated with transaction system 130 (e.g., remittance application 108). Upon a successful authentication of user 101's identity based on processes performed by client device 102 and/or transaction system 130, client device 102 may present, via display unit 116A, one or more digital interfaces that enable user 101 to enter parameter values of one or more of the first or second candidate remittance transactions, and to request an initiation of the first and/or second candidate remittance transactions in accordance with the verified, modified, or augmented parameter values.

As described herein, certain of the disclosed exemplary embodiments may transmit, to client device 102, one or more dynamically generated alerts identifying candidate remittance transactions capable of initiation by user 101 during a corresponding temporal interval. The alerts may, in some instances, be tailored to one or more alert and notification preferences of user 101, and may be generated and presented via display unit 116A automatically and without intervention from user 101. Further, as described herein, user 101 may provide additional input to client device 102, e.g., in response to presented digital interface, that requests an initiation of one or more of the candidate remittance transactions in accordance with parameter values specified by user 101 in accordance with the dynamically generated alerts.

In further embodiments, described below, transaction system 130 may perform any of the exemplary processes described herein to generate provisioning information that includes parameter values characterizing one of more candidate remittance transactions capable of initiation by, or on behalf of, user 101 during a corresponding temporal interval, and that links or associates the generated provisioning information to account data characterizing an account held by user 101 and available to fund each of the candidate remittance transactions. Further, transaction system 130 may perform any of the exemplary processes described herein to incorporate, within corresponding user-specific elements of the generated message data, a unidirectional hyperlink or other selectable elements that references the generated provisioning information.

For example, when presented to user 101 via display unit 116A, user 101 may provide additional input to client device 102 that selects the unidirectional element or selectable links (e.g., via input unit 116B), and in response to the additional input, client device 102 may perform operations that, in conjunction with transaction system 130, generate and present a remittance interface populated with corresponding elements of the generated provisioning information. In some instances, the presented remittance interface may enable user 101 to verify the parameter values that characterize each of the candidate remittance transactions and request an initiation of these candidate remittance transactions based on a single additional input, e.g., a selection of a corresponding interface element or icon within the remittance interface, provided to client device 102 by user 101. In other instances, and as described herein, the presented remittance interface may facilitate a modification or, or an augmentation to, one of more of the presented parameter values, and an initiation of one or more of the candidate remittance in accordance with the modified or augmented parameter values, through a single digital interface.

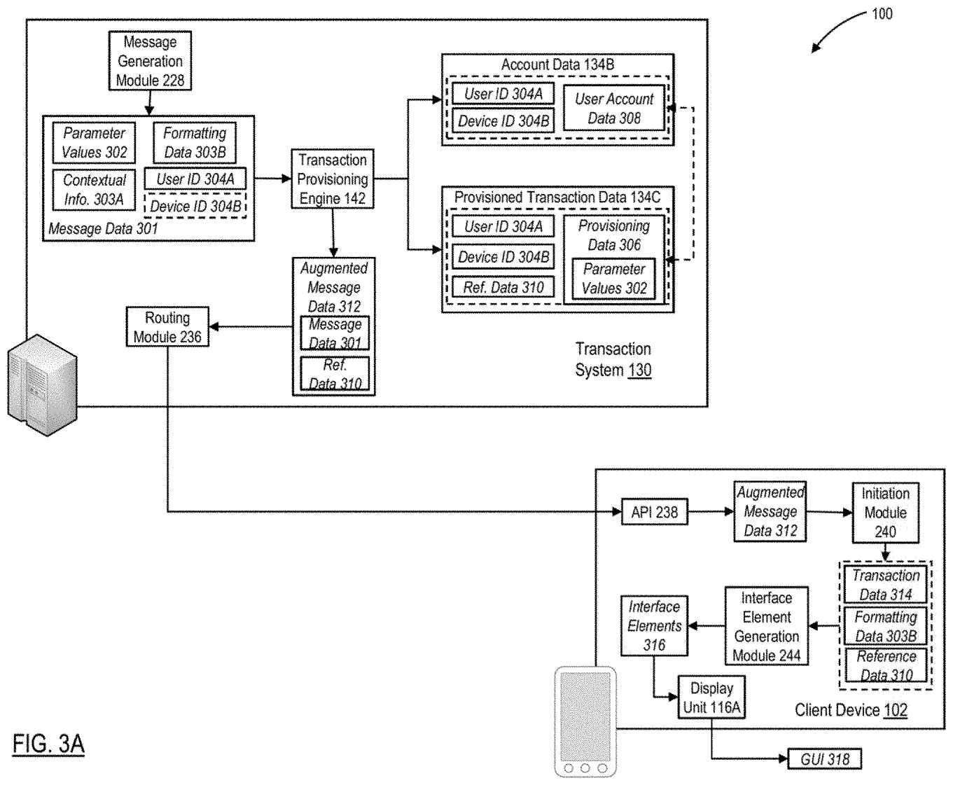

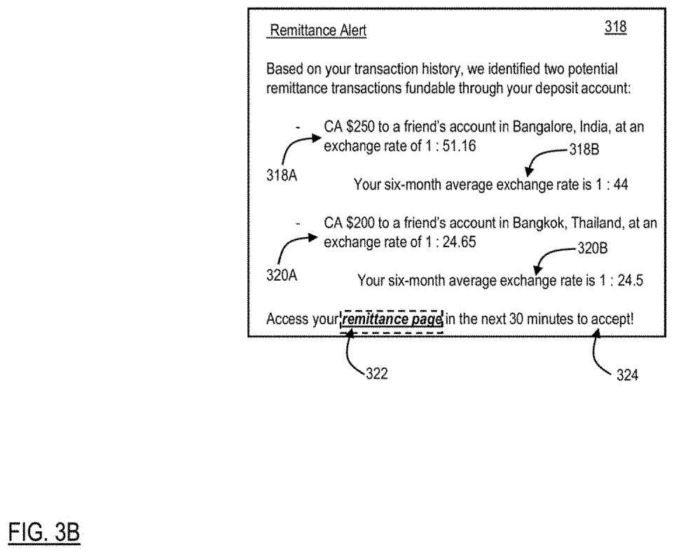

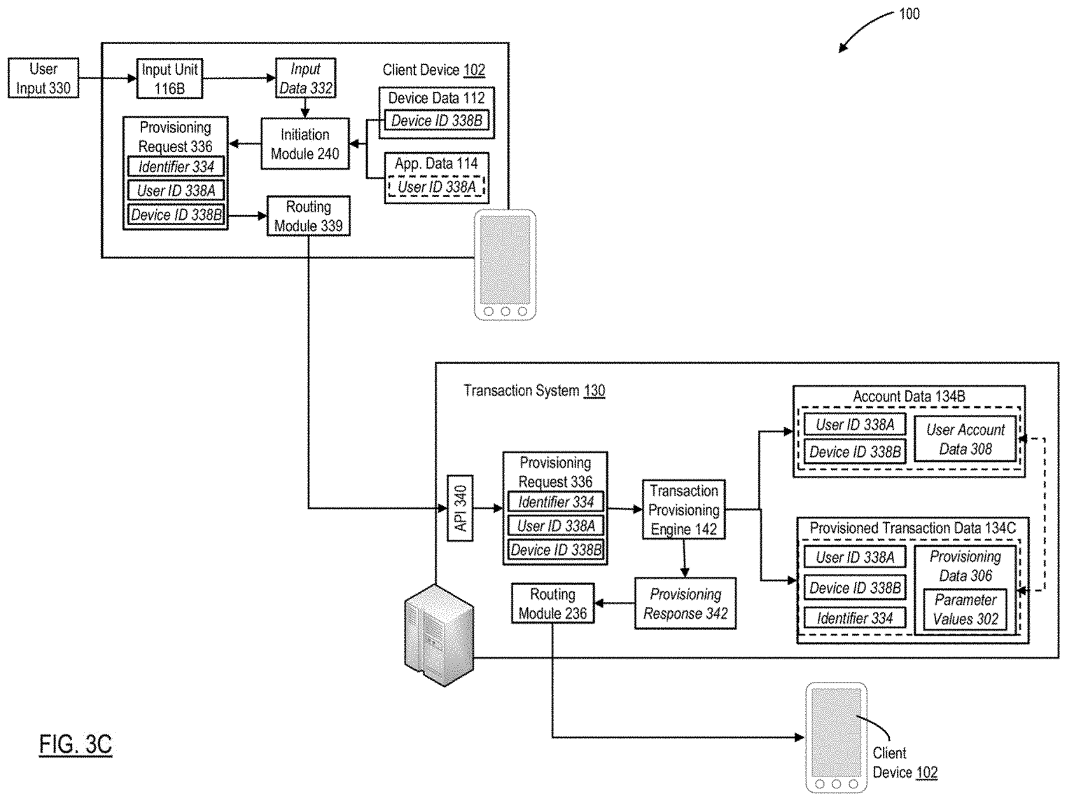

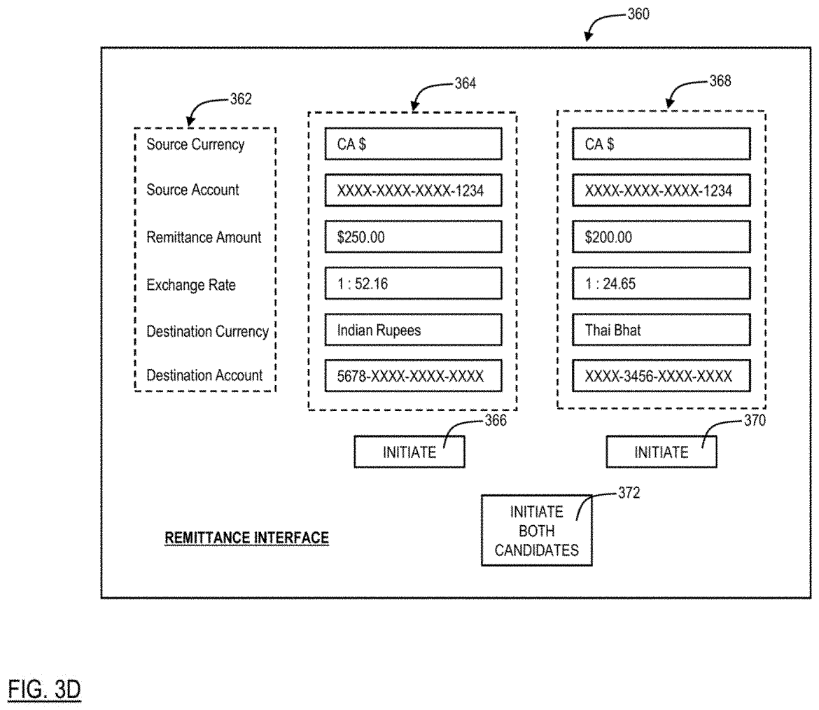

Referring to FIG. 3A, messaging generation module 228 may perform any of the exemplary processes described herein to generate alert messages identifying and characterizing one or more candidate remittance transactions capable of initiation by users of transaction system 130, such as user 101, during a corresponding temporal interval. For example, and as described herein, each of the generated alert messages may be associated with a corresponding one of the users, such as user 101, and may be formatted in accordance with one or more alert and notification preferences maintained locally by transaction system 130, e.g., within profile data 134B of customer account database 134.

In some instances, and as described herein, the portion of the generated alert messages associated with user 101 may identify and characterize one or more candidate remittance transactions capable of initiation by user 101, or on behalf of user 101, during a corresponding temporal interval. For example, the one or more candidate remittance transactions may include, but are not limited to, a first candidate remittance of CA $250 to a destination account denominated in Indian rupees and located in Bangalore, India, and a second candidate remittance of CA $200 to a destination account denominated in Thai baht and located in Bangkok, Thailand.

Further, and as described herein, the generated messages associated with user 101 may be packaged into corresponding message data 301, which includes parameter values 302 that characterize each of the one or more candidate remittance transactions, additional contextual information 303A associated with each of the candidate remittance transactions and further, formatting data 303B that includes formatting and layout data for each of the generated alert messages (e.g., formats or layout specific to, and reflective of, email-based notification, text-message-based notification, browser-based notification, application-based notification, etc.). Further, each of parameter values 302, additional contextual information 303A, and formatting data 303B may linked to corresponding elements of user data 304A that uniquely identifies user 101 (e.g., an alphanumeric login credential of user 101) and device data 304B that uniquely identifiers a device operated by or associated with user 101 (e.g., a network address, such as an IP address or MAC address, assigned to client device 102). Further, although not illustrated in FIG. 3A, transaction system 130 may package the generated alert messages associated with additional, or alternate, users of transaction system 130 into one or more elements of message data (e.g., message data 234 of FIG. 2A), which may include similar sets of parameter values, similar elements of additional contextual information, and corresponding elements of formatting data linked to corresponding user and device identifiers.

For example, and for each candidate remittance transaction associated with user 101, parameter values 302 may include, but are not limited to, an identifier of a source currency (e.g., Canadian dollars) and a destination currency (e.g., Indian rupees or Thai baht), a remitted amount of the source currency (e.g., CA $250 or CA $200), a currently quoted exchange rate, an identifier of a source account capable of funding the remitted amount (e.g., a portion of an account number of user 101's deposit account), and an identifier of a destination account (e.g., a name of the recipient, a tokenized portion of the destination account, etc.). Further, additional contextual information 303A may include, but is not limited to, a running average of a corresponding exchange rate over a temporal interval (e.g., six months), an average time between initiation of remittance transactions involving the destination account, an average amount remitted to the destination account over the temporal interval, and a current balance of user 101's deposit account, e.g., which funds the remitted amount. In some instances, when presented to user 101 via the corresponding digital interface, potions of additional contextual information 303A may enable user 101 to characterize visually a level of conformity between the candidate remittance transaction and a history of remittance transactions involving the destination account.

Further, as described herein, formatting data 303B may include message-specific information that characterizes a format or a layout of interface elements presented within digital interfaces generated in accordance with the alert and notification preferences of user 101. The disclosed embodiments are, however, not limited to these examples of parameter values, additional contextual information, and formatting data, and in other instances, message data 301 (and other elements of messaging data that include alert messages and supporting data associated with other users of transaction system 130) may include any additional or alternate parameter values, additional contextual information, or formatting data appropriate to the candidate remittance transactions associated with user 101.

Referring back to FIG. 3A, message generation module 228 may provide message data 301 as an input to transaction provisioning engine 142, which may perform any of the exemplary processes described herein to generate provisioning information that includes parameter values 302 (and in some instances, contextual information 303A), and further, to link or associate the generated provisioning information to account data characterizing an account held by user 101 and available to fund each of the candidate remittance transactions. For example, and upon execution by transaction system 130, transaction provisioning engine 142 may perform operations that parse message data 301, that extract user data 304A, which includes a unique identifier of user 101 (e.g., an alphanumeric login credential assigned to user 101 by transaction system 130), and in some instances, that also extract device data 304B, which includes a unique identifier of client device 102 (e.g., a network identifier of client device 102, such as an IP address or a MAC address). Further, transaction provisioning engine 142 may perform additional operations that extract parameter values 302 from message data 301 and in some instances that also extract additional contextual information 303A from message data 301.

Executed transaction provisioning engine 142 may package user data 304A and parameter values 302 (and in some instances, device data 304B and/or additional contextual information 303A) into provisioning data 306, which transaction provisioning engine 142 may store within a corresponding portion of customer account database 134, such as provisioned transaction data 134C. Further, in some examples, executed transaction provisioning engine 142 may also access account data 134A (e.g., as maintained within customer account database 134), and identify user account data 308 associated with user data 304A or device data 304B. In some instances, user account data 308 may identify and characterize an account held by user 101 (e.g., a deposit account, a credit card account, etc.) available to fund the candidate remittance transactions, and executed transaction provisioning engine 142 may perform operations that store additional information (e.g., a link, a pointer, etc.) that associates or links provisioning data 306 to user account data 308.

In additional instances, executed transaction provisioning engine 142 may generate reference data 310 establishing a unidirectional hyperlink or other selectable data element that that references provisioning data 306, and associated or linked user account data 308, within customer account database 134 (and store reference data 310 within provisioned transaction data 134C in conjunction with provisioning data 306). Executed transaction provisioning engine 142 may, for example, perform additional operations that package messaging data 301 (e.g., which includes parameter values 302, contextual information 303A, and formatting data 303B) and generated reference data 310 into corresponding portions of augmented message data 312, which executed transaction provisioning engine 142 may provide as an input to routing module 236 of transaction system 130. Further, although not illustrated in FIG. 3A, executed transaction provisioning engine 142 may perform any of the exemplary processes described herein to generate provisioning data specifying parameter values (and in some instances, contextual information) characterizing candidate remittance transactions associated with additional, or alternate, users of transaction system 130, to link the generated provisioning data to accounts held by the additional, or alternate, users, and to generated corresponding portions of augmented message data that references the provisioning data and the linked accounts.

Routing module 236 may perform any of the exemplary processes described herein to transmit augmented message data 312 across network 120 to the unique network address of client device 102 (e.g., the IP or MAC address) using any appropriate communications protocol. As described herein, API 238 of client device 102 may receive and route augmented message data 312 to initiation module 240, which may perform any of the exemplary processes described herein to parse augmented message data 312, identify each of the included alert messages, and identify one or more application programs that, when executed by client device 102, render the alert messages for presentation within a corresponding digital interface (e.g., a messaging application or remittance application 108).

Referring back to FIG. 3A, and upon execution of the message application or remittance application 108, initiation module 240 may parse augmented message data 312 and extract parameter values 302, the corresponding temporal window, contextual information 303A, and formatting data 303B. Further, initiation module 240 may also parse augmented message data 312 to extract reference data 310, which establishes a unidirectional hyperlink or other selectable data element that references provisioning data 306, and associated or linked user account data 308, within customer account database 134.

Initiation module 240 may perform any of the exemplary processes described above to package extract parameter values 302, the corresponding temporal window, and additional contextual information 303A into corresponding portions of transaction data 314. Initiation module 240 may provide transaction data 314, formatting data 303B, and reference data 310 as inputs to an interface element generation module 244 (e.g., associated with the executed messaging application or executed remittance application 108). Interface element generation module 244 may process corresponding portions of transaction data 314, formatting data 303B, and reference data 310 to generate interface elements 316 representative of parameter values 302, the temporal interval, and additional contextual information 303A characterizing each of the candidate remittance transactions, and further, representative of reference data 310 establishing a unidirectional hyperlink or other selectable data element (e.g., that references provisioning data 306, and associated or linked user account data 308, within customer account database 134). Further, and as described herein, generated interface elements 316 may be formatted in accordance with, or may reflect layout information within, corresponding portions of formatting data 303B.

Interface element generation module 244 may route interface elements 316 to display unit 116A of client device 102, which renders interface elements 316 for presentation within a corresponding graphical user interface (GUI) 318. In some instances, GUI 318 may include presented interface elements 318A, which identify and characterize the first candidate remittance transaction (e.g., a remittance of CA $250 to a destination account denominated in Indian rupees and located in Bangalore, India), and presented interface elements 318B, which identifies additional contextual information associated with the first candidate remittance transaction (e.g., a six-month running average of the exchange rate between Canadian dollars and Indian rupees). GUI 318 may also include presented interface elements 320A, which identify and characterize the second candidate remittance transaction (e.g., a remittance of CA $200 to a destination account denominated in Thai baht and located in Bangkok, Thailand), and presented interface elements 320B, which identifies additional contextual information associated with the second candidate remittance transaction (e.g., a six-month running average of the exchange rate between Canadian dollars and Thai baht).

Further, as illustrated in FIG. 3B, GUI 318 may also include hyperlink 322 that, when selected by user 101 (e.g., based on corresponding input provided to client device 102 via input unit 116B), causes client device 102 to generate and present an additional digital interface, e.g., a remittance interface, populated automatically based on portions of provisioning data 306 and user account data 308 maintained locally by transaction system 130 (e.g., within corresponding portions of customer account database 134 of FIG. 1). In additional instances, GUI 318 may present one or more additional interface elements 324 that prompt user 101 to access the remittance interface, e.g., by selecting hyperlink 322, within the temporal interval of validity associated with the candidate remittance transactions (e.g., as represented by presented interface elements 318A, 318B, 320A, and 320B).

For example, upon viewing GUI 318, user 101 may elect to initiate one or more of the first candidate remittance transaction (e.g., as represented by presented interface elements 318A and 318B) or the second candidate remittance transaction (e.g., as represented by presented interface elements 320A and 320B) in accordance with the presented parameter values, and additionally, or alternatively, in accordance with certain desired modification to the presented parameter values. Referring to FIG. 3C, user 101 may, in some instances, provide additional input 330 to client device 102 that selects hyperlink 322, e.g., by establishing contact between a finger of user 101 and a corresponding portion of a surface of a pressure-sensitive, touchscreen display unit that correspond to hyperlink 322.

As illustrated in FIG. 3C, input unit 116B may receive additional user input 330, and may route corresponding input data 332 to initiation module 240 of client device 102. In some instances, input data 332 may include indication indicative of the selection of hyperlink 322 by user 101, and initiation module 240 may perform operations that detect the selection of hyperlink 322 based on an analysis or a processing of input data 332. In response to the detected selection of hyperlink 322, client device 102 may perform operations (not illustrated in FIG. 3C) that generate interface elements corresponding to the remittance interface. Further, and in response to the detected selected of hyperlink 322, initiation module 240 may perform operation that generate (or extract from input data 332) an identifier 334 of selected hyperlink 322, and that package hyperlink identifier 334 into a corresponding portion of provisioning request 336, along with user data 338A (e.g., a unique, alphanumeric login credential of user 101) and/or device data 338B (e.g., a network address of client device 102, such as an IP of MAC address). In some instances, initiation module 240 may access data repository 110, and may extract user data 338A from a corresponding portion of application data 114 and device data 338B from a corresponding portion of device information 112.

Initiation module 240 may provide provisioning request 336 as an input to a routing module 339 of client device 102, which may access a network address of transaction system 130 (e.g., as maintained within one or more tangible, non-transitory memories) and perform operations that cause client device 102 to transmit provisioning request 336 across network 120 to the network address of transaction system 130. As illustrated in FIG. 3C, a secure, programmatic interface of transaction system 130, such as application programming interface (API) 340, may receive and route provisioning request 336 to executed transaction provisioning engine 142. API 340 may be associated with or established by executed transaction provisioning engine 142, and may facilitate secure, module-to-module communications across network 120 between transaction provisioning engine 142 and routing module 339 of client device 102.

In some instances, executed transaction provisioning engine 142 may receive provisioning request 336 and perform operations that extract user data 338A, device data 338B, and hyperlink identifier 334. Further, executed transaction provisioning engine 142 may access provisioned transaction data 134C (e.g., as maintained within customer account database 134 of FIG. 1), and identify one or more elements of provisioned transaction data, such as provisioning data 306, that are associated with hyperlink identifier 334 and further, that include or reference user data 338A and/or device data 338B. Executed transaction provisioning engine 142 may perform additional operations that parse account data 134A (e.g., as also maintained within customer account database 134 of FIG. 1) to identify one or more elements of account data, such as user account data 308, that are associated with user data 338A and/or device data 338B and further, that are linked to provisioning data 306. As described herein, user account data 308 may identify and characterize an account held by user 101 and available to fund the candidate remittance transactions identified and characterized within provisioning data 306.

Executed transaction provisioning engine 142 may perform operations that package provisioning data 306 and user account data 308 into corresponding portions of provisioning response 342. In some instances, provisioning data 306 may include parameter values that characterize one or more candidate remittance transactions capable of initiation by user 101, or on behalf of user 101, during a corresponding temporal interval. For example, and as descried herein, the candidate remittance transactions may include, but are not limited to, the first candidate remittance transaction (e.g., the first candidate remittance of CA $250 to the first destination account denominated in Indian rupees and located in Bangalore, India) and the second candidate remittance transaction (e.g., the second candidate remittance of CA $200 to the second destination account denominated in Thai baht and located in Bangkok, Thailand). Further, the parameter data characterizing each of the candidate remittance transactions may include, among other things, an identifier of a source currency (e.g., Canadian dollars) and a destination currency (e.g., Indian rupees or Thai baht), a remitted amount of the source currency (e.g., CA $250 or CA $200), a currently quoted exchange rate, an identifier of a source account capable of funding the remitted amount (e.g., a portion of an account number of user 101's deposit account), and an identifier of a destination account (e.g., a name of the recipient, a tokenized portion of the destination account, etc.).

In some instances, executed transaction provisioning engine 142 may provide provisioning response 342 as an input to a corresponding routing module, such as routing module 236. As described herein, routing module 236 may perform operations that cause transaction system 130 to transmit provisioning response 342 across network 120 to the network address of client device 102, e.g., as specified within device data 338B. Although not illustrated in FIG. 3C, client device 102 may receive provisioning response across a secure, programmatic interface, such as an application programming interface, and may perform operations that populate the interface elements of the remittance interface with corresponding portions of provisioning response 342 (e.g., discrete parameter values within provisioning data 306 or portions of user account data 308). Client device 102 may perform any of the exemplary processes described herein to present, via display unit 116A, the populated interface elements within a corresponding graphical user interface, such as remittance interface 360 of FIG. 3D.

For example, remittance interface 360 may include presented interface elements 362, which include identifies of each of the parameters of the candidate remittance transactions specified within provisioning response 342, e.g., “Source Currency,” “Source Account,” “Remitted Amount,” “Exchange Rate,” “Destination Currency,” and “Destination Account.” Remittance interface 360 may include interactive interface elements 364, such as fillable text boxes, that are populated with corresponding parameter values that characterize the first candidate remittance transaction, e.g., the first candidate remittance of CA $250 to a destination account denominated in Indian rupees and located in Bangalore, India. Remittance interface 360 may also include an initiation icon 366 that, when selected by user 101, causes client device 102 to perform operations that request an initiation of the first candidate remittance transaction in accordance with the populated parameter values.

Further, as illustrated in FIG. 3D, remittance interface 360 may also include interactive interface elements 368, such as fillable text boxes, that are populated with corresponding parameter values that characterize the second candidate remittance transaction, e.g., the second candidate remittance of CA $200 to a destination account denominated in Thai baht and located in Bangkok, Thailand. Remittance interface 360 further includes an initiation icon 370 that, when selected by user 101, causes client device 102 to perform operations that request an initiation of the second candidate remittance transaction in accordance with the populated parameter values. In some instances, remittance interface 360 may include an additional initiation icon 372 that, when selected by user 101, causes client device 102 to perform operations that request an initiation of both the first and second candidate remittance transactions in accordance with corresponding ones of the populated parameter values.

By way of example, user 101 may view presented remittance interface 360, e.g., via display unit 116A of client device 102, and may elect to initiate the first candidate remittance transaction (e.g., the first candidate remittance of CA $250 to a destination account denominated in Indian rupees and located in Bangalore, India) in accordance with the populated parameter values, and may provide, to input unit 116B of client device 102, any of the exemplary input described herein that selects initiation icon 366. Additionally, or alternatively, user 101 may elect to initiate the second candidate remittance transaction (e.g., the second candidate remittance of CA $200 to a destination account denominated in Thai baht and located in Bangkok, Thailand) in accordance with the populated parameter values, and may provide, to input unit 116B, any of the exemplary input described herein that selects initiation icon 370. In other instances, and upon viewing remittance interface 360, user 101 may elect to initiate both the first and second candidate remittance transactions in accordance with corresponding ones of the populated parameter values, and as described herein, user may provide, to input unit 116B, input that selects initiation icon 372.

In some examples, not illustrated in FIGS. 3A-3D, initiation module 240 of client device 102 may receive corresponding input data from input unit 116B. The corresponding input data may identify user 101's selection of the first candidate remittance transaction, the second candidate remittance transaction, or both the first and second candidate remittance transactions for initiation, execution, and settlement based on corresponding one of the populated parameters values, e.g., as provisioned to the account of user 101 by transaction system 130. Initiation module 240 may perform operations that generate selected transaction data 402, which specifies the selection of the first, the second, or the first and second candidate remittance transactions, and may package selected transaction data 402 into a corresponding portion of an initiation request 404, along with user data 338A (e.g., the unique, alphanumeric login credential of user 101) and device data 338B (e.g., the unique network identifier of client device 102, such as an IP or a MAC address).

In other instances, and in addition to selecting of the first, the second, or the first and second candidate remittance transactions for initiation, user 101 may provide additional input to client device 102 (e.g., via input unit 116B) that modifies one or more of the parameter values populated within one or more of interactive interface elements 364 (e.g., corresponding to the first candidate remittance transaction) or interactive interface elements 368 (e.g., corresponding to the second candidate remittance transaction). Based on the additional input, initiation module 240 may perform further operations that package the modified parameter value and a corresponding parameter identifier within an additional portion selected transaction data 402, and may link the modified parameter value (and the parameter identifier) to corresponding ones of user data 338A and/or device data 338B.

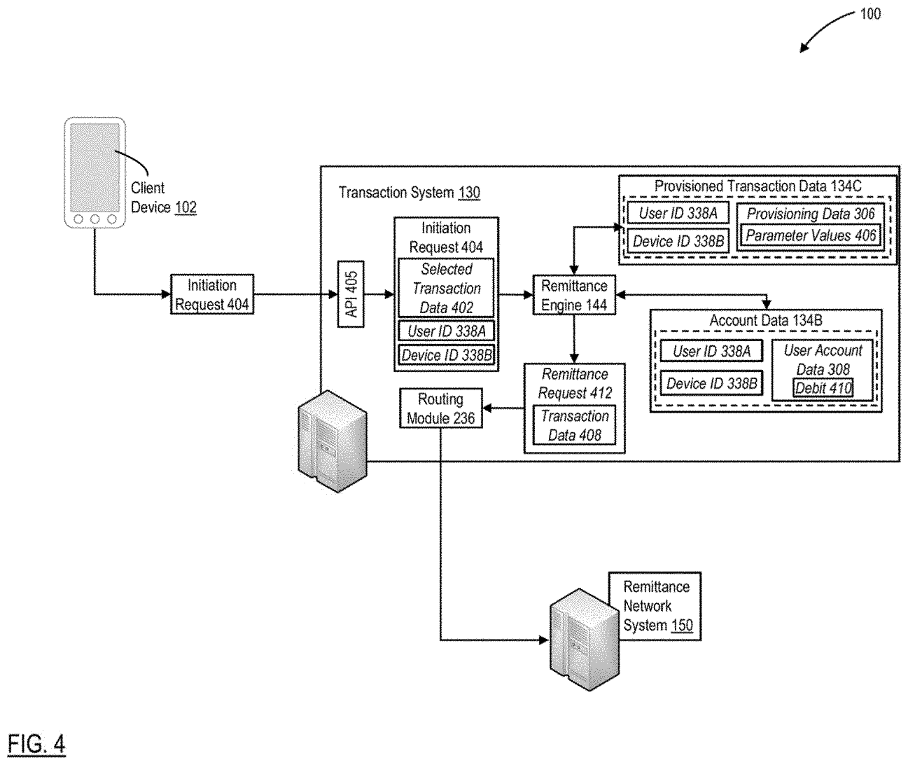

As illustrated in FIG. 4, client device 102 may perform any of the exemplary processes to transmit initiation request 404 across network 120 to the network address of transaction system 130, e.g., using any appropriate communications protocol. A secure, programmatic interface of transaction system 130, such as application programming interface (API) 405, may receive and route initiation request 404 to remittance engine 144 of transaction system 130. For example, API 405 may be associated with or established by remittance engine 144, and may facilitate secure, module-to-module communications across network 120 between remittance engine 144 and initiation module of client device 102.

In some instances, and upon execution by transaction system 130, remittance engine 144 may receive initiation request 404, and may parse initiation request 404 to extract selected transaction data 402, user data 338A, and in some instances, device data 338B. As described herein, selected transaction data 402 may include information that identifies one, or more, of the provisioned candidate remittance transactions for initiation, and executed remittance engine 144 may perform operations that access provisioned transaction data 134C (e.g., as maintained within customer account database 134) and identify and load provisioning data 306, which includes or references user data 338A and/or device data 338B.

Based on the information within selected transaction data 402, executed remittance engine 144 may extract one or more portions of provisioning data 306, e.g., provisioned data portions 406, that correspond to each of the selected candidate remittance transactions, such as, but not limited to, the first, second, or the first and second candidate remittance transactions described herein. In some instances, provisioned data portions 406 may include structured data specifying the parameter values that characterize each selected candidate remittance transaction, and examples of the parameter values include, but are not limited to, an identifier of a source currency and a destination currency, a remitted amount of the source currency, a currently quoted exchange rate, an identifier of a source account capable of funding the remitted amount, and an identifier of a destination account.

For example, executed remittance engine 144 may perform operations that package provisioned data portions 406 into corresponding portions of transaction data 408. Further, and as described herein, selected transaction data 402 may also include one or more parameter values selectively modified based on input provided to client device 102 by user 101, and further, corresponding parameter identifiers linked to each of the one or more modified parameter values. In some instances, not illustrated in FIG. 4, executed remittance engine 144 may identify the parameter values within transaction data 408 that correspond to the selectively modified parameter values within selected transaction data 402, and replace the identified parameter values in transaction data 408 with the selectively modified parameter values.

Referring back to FIG. 4, executed remittance engine 144 may also access account data 134A (e.g., as maintained within customer account database 134) and identify user account data 308, which is associated with user data 338A and/or device data 338B. As described herein, user account data 308 may include information identifying and characterizing an account held by user 101 and capable of funding each of the candidate remittance transactions, such as, but not limited to, a user-specific identifier of the account, a portion of a tokenized (or actual) account number, and data indicative a status, such as a current balance, of the account. For example, the account may include a deposit account held by user 101, and executed remittance engine 144 may perform operations that initiate a remittance transaction in accordance with transaction data 408 by storing, within user account data 308, debit data 410 that reduces an available balance of the deposit account by an amount of consistent with the aggregated remittance amount of each selected candidate remittance transaction (e.g., CA $250 for the first candidate remittance transaction, CA $200 for the second candidate remittance transaction, or CA $450 for both the first and second candidate remittance transactions).

Executed remittance engine 144 may also package transaction data 408 into a corresponding portion of remittance request 412. In some instances, remittance request 412 may also include a unique identifier of transaction system 130, such as an IP or MAC address assigned to transaction system 130, and one or more elements of cryptographic data that enable one or more computer systems associated with a corresponding remittance network, such as remittance network system 150, to verify an identity of transaction system 130 or an integrity of remittance request 412. Examples of the cryptographic data include, but are not limited to, a cryptogram formatted in accordance with a remittance protocol, a hash value, a cryptographic key or digital signature, or a cryptographic commitment.

Further, executed remittance engine 144 may provide remittance request 412 as an input to a routing module of transaction system 130, such as routing module 236. In some instances, routing module 236 may obtain a unique network identifier of remittance network system 150, e.g., from one or more tangible, non-transitory memories, and may perform operations that cause transaction system 130 to route remittance request 412 across network 120 to remittance network system 150, e.g., using any appropriate communications protocol.

Remittance network system 150 may receive remittance request 412 through a secure, programmatic interface, and may perform operations that authenticate and identity of transaction system 130 and additionally, or alternatively, that verify an integrity of remittance request 412, based on corresponding ones of the unique identifier of transaction system 130 (e.g. the network identifier) or the one or more elements of cryptographic data. In response to a successfully authenticated system identity, or a successfully verified request integrity, remittance network system 150 may perform any of the exemplary processes described herein to execute and settle each of the remittance transactions identified within transaction data 408 based on corresponding ones of the specified parameters.

For example, for each of the identified remittance transactions (e.g., the first, second, or the first and second candidate remittance transactions described herein), remittance network system 150 may perform operations that convert the remitted amount of source currency into the specified destination currency in accordance the currently quoted exchange rate, and that credit a corresponding converted amount of the destination currency into the destination account. The destination account may, for example, held by a recipient and issued by financial institution located in a foreign country, or alternatively, may be held by or associated with a corresponding RSP, which may distribute an amount of currency consistent with the destination amount and denominated in the destination currency to the recipient. Further, although not illustrated in FIG. 4, remittance network system 150 may generate and transmit data confirming the successful execution and settlement of each of the identified remittance transactions across network 120 to transaction system 130 (e.g., through a secure, programmatic interface), and transaction system 130 may perform additional operations that route the confirmation data to client device 102 in accordance with alert and notification preferences specified by user 101.

In some examples, as described herein, transaction system 130 may perform operations that, in conjunction with remittance network system 150, initiate, execute, and settle one or more provisioned remittance transactions based on confirmatory input received from client device 102, e.g., in response the generation and presentation by client device 102 of a remittance interface populated automatically within parameter values characterizing the one or more provisioned remittance transactions. Certain of these exemplary processes, which automatically populate a remittance interface with parameter values determined based an application of one or more adaptive and dynamic processes to portions of monitored account data, exchange-rate data, and transaction, and which enable user 101 to initiate one or more of the provisioned remittance transactions based on a selection of a single interface element, can be implemented in addition to, or as an alternate to, conventional processes that initiate remittance transactions based on user-specified parameters provided as input to corresponding network-connected devices.

By populating generated and presented remittance interfaces automatically with adaptively and dynamically determined parameter values, and by enabling an initiation one or one remittance transactions based on a single input operation provided to client device 102 in response to the generated and presented interfaces, certain of the exemplary processes described herein may improve an accuracy of the parameter values that characterize the one or more remittance transactions, and may improve an efficiency and an ability of user 101 to access the graphical user interfaces described herein. Further, by enabling the initiation one or one of the remittance transactions based on a single input operation, certain of these exemplary processes may extend an ability of user 101 to interact with complicated remittance interfaces network-connected devices characterized by limited input functionalities or limited display functionality, such as wearable communications networks (e.g., smart watches) and wearable form factors.

The disclosed embodiments are, however, not limited to processes in which transaction system 130 initiates a remittance transaction based on confirmatory input provided by user 101, e.g., via client device 102. In other exemplary embodiments, described herein, transaction system 130 may maintain, within one or more tangible, non-transitory memories, a consent database that includes one or more rules (e.g., “pre-approval criteria”) identifying parameter values, or ranges of parameter values, that characterize one or more remittance transactions pre-approved for initiation by user 101 (e.g., “pre-approved” remittance transactions). For example, transaction database 136 may establish all or a portion of the consent database during an initial registration process implemented by client device 102 and transaction system 130, and user 101 may augment, modify, or delete portions of the consent database by providing additional input to transaction system 130 via client device 102, e.g., in response to a digital interface associated with transaction system 130 and displayed on display unit 116A by client device 102, such as that rendered for presentation by an executed web browser or by executed remittance application 108.

For example, the pre-approval criteria may specify threshold values associated with one or more pre-approved remittance transactions, such as, but not limited to, a maximum remitted amount of a source currency, a maximum exchange rate between the source currency and one or more destination currencies, or a maximum, or minimum, delay between successively initiated remittance transactions. In other examples, the pre-approval criteria may specify temporal intervals during which user 101 pre-approved remittance transactions for initiation using any of the exemplary processes described herein. Additionally, or alternatively, the pre-approval criteria may identify one or more specific, pre-approved parameter values such as, but not limited to, a pre-approved destination currency or a pre-approved destination account. The disclosed embodiments are, however, not limited to these examples of pre-approval criteria, and in other instances, the consent database may establish and maintain any additional or alternate pre-approval criteria that would be apparent and appropriate to user 101 or remittance network system 150.

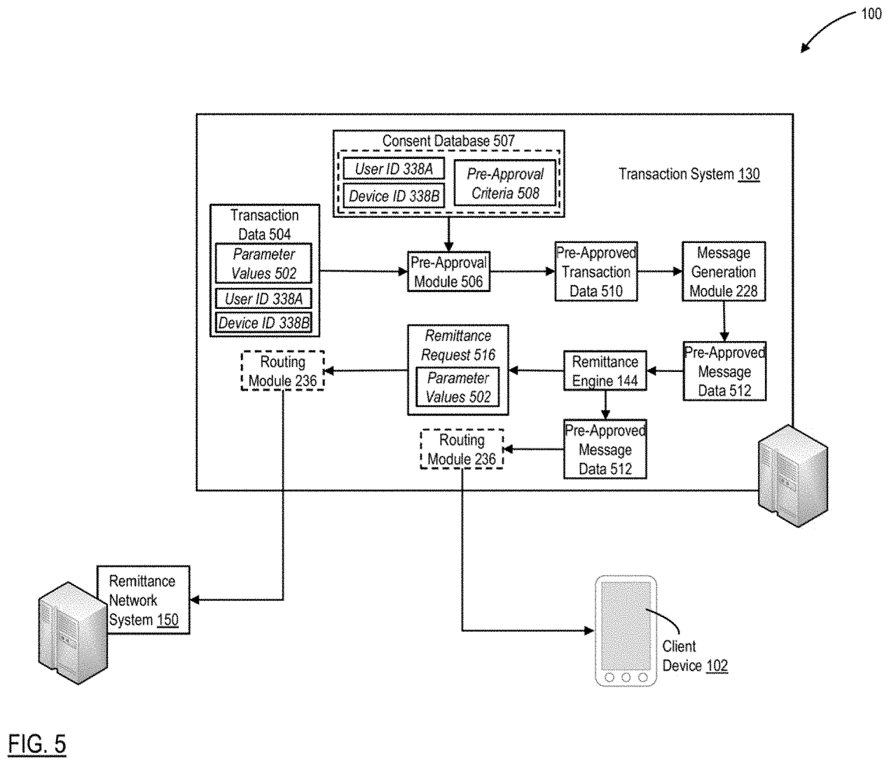

In some instances, transaction system 130 may perform any of the exemplary adaptive and dynamic processes described herein generate one or more parameter values of a candidate data exchange that are consistent with imposed constraints and further, satisfy at least one alert criteria (e.g., that a corresponding propensity score exceeds a corresponding threshold value). For example, and referring to FIG. 5, transaction system 130 may perform operations that package the one or more generated parameter values, e.g., parameter values 502, into corresponding portions of candidate transaction data 504, along with user data 338A (e.g., the unique, alphanumeric login credential of user 101) and in some instances, device data 338B (e.g., a unique network identifier of client device 102, such as an IP address of a MAC address).

For example, candidate transaction data 504 may identify a candidate remittance of CA $250 to a destination account denominated in Indian rupees and located in Bangalore, India. Further, parameter values 502, which characterize the candidate remittance, may include, but are not limited to, an identifier of a source currency (e.g., Canadian dollars) and a destination currency (e.g., Indian rupees), a remitted amount of source currency (e.g., CA $250), an identifier of a source account available to fund the candidate remittance transaction (e.g., tokenized or actual account data associated with user 101's deposit account), a currently quoted exchange rate (e.g., 1:52.16), and an identifier of a destination account (e.g., tokenized or actual account data, etc.).

Referring back to FIG. 5, a pre-approval module 506 of transaction system 130 may receive candidate transaction data 504, and may perform operations that extract parameter values 502 and user data 338A (and in some instances device data 338B) from corresponding portions of candidate transaction data 504. Further, pre-approval module 506 may access locally stored consent database 507 (e.g., as maintained within the one or more tangible, non-transitory memories of transaction system 130), and based on user data 338A and/or device data 338B, load pre-approval criteria 508 established and maintained one behalf of user 101. In some instances, pre-approval module 506 may perform operations that determine whether parameter values 502 of candidate transaction data 504 are consistent with each of loaded pre-approval criteria 508.

For example, loaded pre-approval criteria 508 may, among other things, specify that a candidate remittance transaction is subject to pre-approval by user 101 when a remitted amount of source currency falls below a threshold amount of CA $300 and when a corresponding rate of exchange between Canadian dollars and Indian rupees exceed a threshold rate of 1:45. In some instances, pre-approval module 506 may determine that parameter values 502, which includes a remitted account of CA $250 and a currently quoted exchange rate of 1:52.26, satisfy and are consistent with each of pre-approval criteria 508 and as such, the pre-approval module 506 may determine the candidate remittance transaction characterized by parameter values 502 is pre-approved for initiation by user 101. Based on the determined pre-approval, pre-approval module 506 may package parameter values 502 and user data 338A (and in some instances, device data 338B) into corresponding portions of pre-approved transaction data 510, which pre-approval module 506 may provide as an input to message generation module 228 and to remittance engine 144.

In some instances, message generation module 228 may receive pre-approved transaction data 510, which includes parameter values 502 of the now pre-approved remittance of CA $250 to the destination account denominated in Indian rupees and located in Bangalore, India. Message generation module 228 may perform any of the exemplary processes described herein to generate, for user 101, one or more alert messages identifying and characterizing the pre-approved remittance transaction in accordance with one or more alert and notification preferences of user 101. As described herein, the alert and notification preferences may specify, for user 101, one or more preferred modes communication for receiving generated alerts or notification, such as, but not limited to, a preference for receiving alerts or notifications via email, via text message (e.g., by one or more executed messaging applications, such as WhatsApp™), via browser notification (e.g., by a notification delivered to, and presented within, an executed web browser), or via application-specific notification (e.g., within a digital interface generated by executed remittance application 108).

Further, in some instances, each of the one or more generated alert messages may include pre-approved parameter values 502 (or alternatively, a portion of pre-approved parameter values 502 consistent with a corresponding one of the user-specified alert and notification preferences), and may also specify the initiation of the pre-approved remittance transaction in accordance with pre-approved parameter values 502. As described herein, message generation module 228 may perform any of the exemplary processes described herein to package the one or more generated alert messages into corresponding message data, such as pre-approved message data 512, along with additional information that identifies a network address of client device 102, such a device data 338B.

Message generation module 228 may provide pre-approved message data 512 as an input to remittance engine 144, which as illustrated in FIG. 5, also receives pre-approved transaction data 510 from pre-approval module 506. In some instances, and upon execution by transaction system 130, remittance engine 144 may perform any of the exemplary processes described herein to initiate the pre-approved remittance transaction by modifying a portion of stored user account data 308 to reflect a debit in the amount of CA $250 from the deposit account held by user 101 (not illustrated in FIG. 5), to generate a remittance request 514 that includes all, or a portion of, pre-approved parameter values 502 (e.g., as extracted from pre-approved transaction data 510), and to transmit generated remittance request 514 across network 120 to remittance network system 150. Remittance network system 150 may receive remittance request 514 through a secure, programmatic interface, and may perform any of the exemplary processes described herein to execute and settle the pre-approved remittance transaction in accordance with pre-approved parameter values 502.

Further, and as illustrated in FIG. 5, executed remittance engine 144 may provide pre-approved message data 512 as an input to a corresponding routing module of transaction system 130, such as routing module 236, which may perform any of the exemplary processes described herein to transmit each of the alert message across network 120 to the network address of client device 102. As described herein, client device 102 may receive each of the alert messages, and may perform operations that render each of the alert messages for presentation within a digital interface generated by a corresponding executed application program, e.g., as specified within the one or more alert and notification preferences of user 101.

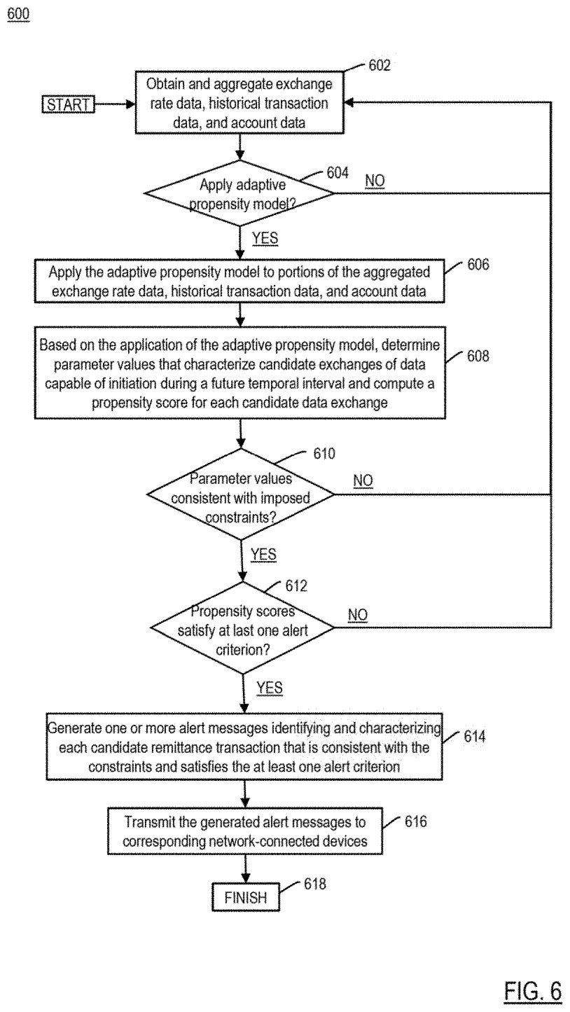

FIG. 6 is a flowchart of an exemplary process 600 for dynamically provisioning and initiating exchanges of data between network-connected devices and systems based on aggregated contextual information. In some examples, a network-connected computing system, such as transaction system 130 of FIG. 1, may perform one or more of the exemplary steps of process 600.

Referring to FIG. 6, transaction system may perform any of the exemplary processes described herein to monitor, obtain, and aggregate elements of contextual information that identify one or more exchanges of data initiated during a prior temporal interval, and additionally, or alternatively, that identify a current value of one or more parameters that characterize these initiated data exchanges and a status of one or more accounts associated with, or involved in, corresponding ones of the initiated data exchanges (e.g., in step 602). By way of example, and as described herein, the one or more exchanges of data may include a remittance transaction that facilitates a cross-border electronic transfer of a remitted amount of funds between a source account held by a user of transaction system 130, such as user 101, and destination account denominated in a destination currency, e.g., a foreign currency.

As described herein, the contextual information may include, but is not limited to: (i) exchange-rate data that characterizes a current rate of exchange between various currencies (and a corresponding period of validity for that current rate) and a time evolution of these exchanges rates over a prior temporal interval; (ii) historical transaction data that identifies and characterizes prior remittance transactions initiated by, or one behalf of, one or more users of transaction system 130, such as user 101; and (ii) account data that identifies and characterizes accounts held by the one or more users and available to fund remittance transactions, such as, but not limited to, a deposit account held by user 101 and issued by a financial institution associated with transaction system 130. In some instances, transaction system 130 may perform operations that generate locally one or more portions of the exchange rate data, historical transaction data, and account data, although in other instances, transaction system 130 may obtain all, or a portion, of the exchange rate data, historical transaction data, and account data from one or more external, network-connected computing systems through a secure, programmatic interface, such as data provider system 148 of FIG. 1.

In some instances, transaction system 130 may perform any of the exemplary processes described herein to determine whether to apply an adaptive propensity model to portions of the obtained and aggregated exchange rate data, historical transaction data, and account data (e.g., in step 604). By way of example, transaction system 130 may be configured to apply the adaptive propensity model to the portions of the exchange rate data, historical transaction data, and account data in accordance with a predetermined schedule (e.g., at fifteen-minute intervals, thirty-minute intervals, hourly intervals, etc.), and additionally, or alternatively, upon detecting an update one or more portions of the exchange rate data, historical transaction data, or account data. In other instances, transaction system 130 may determine a temporal interval separating a current time and a time associated with a prior application of the adaptive propensity model, and may elect to apply the adaptive propensity model to the portions of the exchange rate data, historical transaction data, and account data when that temporal interval exceeds a threshold value.

If transaction system 130 were to decline to apply the adaptive propensity model (e.g., step 604; NO), exemplary process 600 may pass back to step 602, and transaction system 130 may perform any of the exemplary processes described herein to obtain and aggregate additional elements of the exchange rate data, historical transaction data, and account data.

Alternatively, if transaction system 130 were to elect apply the adaptive propensity model (e.g., step 604; YES), transaction system 130 may perform any of the exemplary processes described herein that apply the adaptive propensity model to one or more elements of the aggregated exchange rate data, historical transaction data, and account data (e.g., in step 606). Further, and based on the application of the adaptive propensity model, transaction system 130 may perform any of the exemplary processes described herein to determine parameter values characterizing one or more candidate remittance transactions capable of initiation by, or on behalf of, each of the corresponding users of transaction system 130 during a corresponding future temporal interval, and to compute a propensity score for each of the candidate remittance transactions (e.g., in step 608).

By way of example, the parameter values for each of the candidate remittance transactions may include, but are not limited to, an identifier of a source currency and a destination currency, a remitted amount of the source, a currently quoted exchange rate, an identifier of a source account capable of funding the remitted amount, and an identifier of a destination account. As described herein, the propensity score associated with a corresponding one of the candidate remittance transactions may be indicative of a likelihood that a corresponding user of transaction system 130, e.g., user 101, will initiate the candidate remittance transaction in accordance with the corresponding parameter values during the corresponding temporal interval. Further, the adaptive propensity model may be established by, or may implement, any of the exemplary deterministic or stochastic statistical algorithms, the exemplary adaptive classification models, the exemplary machine learning algorithms, or other adaptive processes described herein.

In some instances, transaction system 130 may perform operations that identify one or more of the candidate remittance transactions characterized by parameter values that are consistent with one or more constraints (e.g., in step 610). By way of example, and as described herein, the one or more constraints may include, but are not limited to, a rate-specific constraint (e.g., a maximum exchange rate for a candidate remittance transaction), an account-specific constraint (e.g., a minimum balance associated with an account that funds a candidate remittance transaction), and a transaction-specific constraint (e.g., a maximum time between successive initiated remittance transaction or a maximum remittance amount imposed by a corresponding remittance network).

If transaction system 130 were to establish an inconsistency between the parameter values characterizing each of the candidate remittance transactions and the one or more constraints (e.g., step 610; NO), exemplary process 600 may pass back to step 602, and transaction system 130 may perform any of the exemplary processes described herein to obtain and aggregate additional elements of the exchange rate data, historical transaction data, and account data.

Alternatively, if transaction system 130 were to determine that the parameter values characterizing one or more of the candidate remittance transactions are consistent with one or more constraints (e.g., step 610; YES); transaction system 130 may perform additional operations that determine whether the propensity score of these “consistent” candidate remittance transactions satisfy at least one alert criterion (e.g., in step 612). As described herein, the at least one alert criterion may specify, among other things, a threshold propensity value, and one of the candidate remittance transactions may satisfy the at least one criterion when the associated propensity value exceeds the threshold propensity value. The disclosed embodiments are, however, not limited to these exemplary alert criteria and in other instances, transaction system 130 may apply any additional, or alternate, alert criterion appropriate to the parameter values characterizing each of the candidate remittance transactions (e.g., in step 612).

If transaction system 130 were to determine that the propensity scores associated with the “consistent” candidate remittance transactions fail to satisfy the at least one alert criterion (e.g., step 612; NO), exemplary process 600 may pass back to step 602, and transaction system 130 may perform any of the exemplary processes described herein to obtain and aggregate additional elements of the exchange rate data, historical transaction data, and account data.

Alternatively, if transaction system 130 were to determine that the propensity score associated with at least one of the consistent candidate remittance transactions satisfies the at least one alert criterion (e.g., step 612; YES), transaction system 130 may perform any of the exemplary processes described herein to generate, one or more alert messages identifying and characterizing each of the candidate remittance transactions that are consistent with the one or more constraints and that satisfies the at least one alert criterion (e.g., in step 614). In some instances, and as described herein, transaction system 130 may generate the one or more alert messages in accordance with one or more alert and notification preferences established by users associated with corresponding one of the candidate remittance transactions, e.g., based on locally maintained profile data and corresponding template data.

Transaction system 130 may also perform any of the exemplary processes described herein to transmit subsets of the generated alert messages to network-connected devices or systems operated by, or associated with, corresponding ones of the users (e.g., in step 616). For example, and as described herein, each subset of the generated alert messages may be associated with a corresponding user and may be consistent with the alert and notification preferences established by that corresponding user. In some instances, each of the network-connected devices or systems, such client device 102, may receive a subset of the generated alert messages, and executed application programs consistent with the alert and notification preferences of the corresponding user may render respective ones of the subset of the alert messages for presentation within a digital interface. Exemplary process 600 is the complete in step 618.

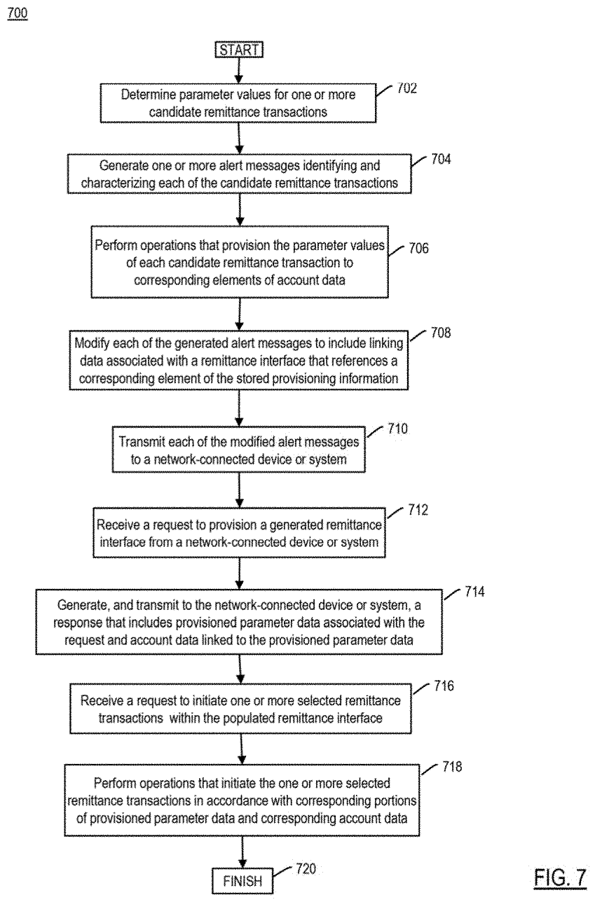

FIG. 7 is a flowchart of an additional exemplary process 600 for dynamically provisioning and initiating exchanges of data between network-connected devices and systems based on aggregated contextual information. In some examples, a network-connected computing system, such as transaction system 130 of FIG. 1, may perform one or more of the exemplary steps of process 700.

Referring to FIG. 7, transaction system 130 may perform any of the exemplary processes described herein to determine parameter values for one or more candidate remittance transactions that are capable of initiation by, or on behalf of, corresponding users of transaction system 130 during a future temporal interval and further, that are consistent with one or more constraints and satisfy at least one alert criterion (e.g., in step 702). For example, and as described herein, each of the candidate remittance transactions may be associated with a corresponding user, such as user 101, and the parameter values for each of the candidate remittance transactions may include, but are not limited to, an identifier of a source currency and a destination currency, a remitted amount of the source, a currently quoted exchange rate, an identifier of a source account capable of funding the remitted amount, and an identifier of a destination account.

Transaction system 130 may also perform any of the exemplary processes described herein to generate one or more alert messages identifying and characterizing each of the candidate remittance transactions (e.g., in step 704). In some instances, and as described herein, transaction system 130 may generate the one or more alert messages in accordance with one or more alert and notification preferences established by users associated with corresponding one of the candidate remittance transactions, e.g., based on locally maintained profile data and corresponding template data.

Transaction system 130 may also perform any of the exemplary processes described herein to generate provisioning information for each of the candidate remittance transactions and to link or associate the generated provisioning information to account data characterizing an account available to fund corresponding ones of the candidate remittance transactions (e.g., in step 706). As described herein, the generated provisioning information may include the parameter values that characterize the candidate remittance transactions, and transaction system 130 may associate each element of the generated provisioning information to a unique user identifier (e.g., a login credential of user 101) and in some instances, a unique device identifier (e.g., a network address assigned to client device 102). Further, transaction system 130 may perform additional operations to store each element of the generated provisioning information, and the associated user identifier (and in some instances, the associated device identifier) within a locally accessible data repository, such as provisioned transaction data 134C of FIG. 1, and that associate the stored elements of the generated provisioning information with an element of stored account data that includes, or references, the user identifier of the device identifier.

Referring back to FIG. 7, transaction system 130 may perform any of the exemplary processes described herein to modify each of the generated alert messages to include reference data, such as hyperlink data, associated with a remittance interface that references a corresponding element of the provisioning information (e.g., in step 708). Transaction system 130 may also perform any of the exemplary processes described herein to transmit each of the modified alert messages to a corresponding network-connected device or system (e.g., in step 710).

As described herein, a network-connected device, such as client device 102, may receive one or more of the modified alert messages, and may perform operations that render the one or more modified alert messages for presentation within a corresponding graphical user interface, such as GUI 318 of FIG. 3C. In some instances, the presented alert messages may include a hyperlink or other selectable interface element that references a remittance interface provisionable by transaction system 130, such as hyperlink 322 of GUI 318 of FIG. 3C. Further, and upon viewing an alert message presented by a corresponding network-connected device, such as client device 102, a user, such as user 101, may elect to initiate one or more of the candidate remittance transactions identified and characterized by the alert message, and may provide additional input to the network-connected device that selects the hyperlink or other selectable interface element, which causes the network-connected device to launch the remittance page. Further, using any of the exemplary processes described herein, the network-connected device may generate and transmit, to transaction system 130 across network 120, a request to provision the launched remittance interface that include the corresponding user identifier or the corresponding device identifier.

Referring back to FIG. 7, transaction system 130 may receive the request to provision the remittance interface (e.g., in step 712), and may perform any of the exemplary processes described herein to obtain a portion of the provisioning information associated with the user identifier or the device identifier, and a portion of the stored account data linked to the portions of the provisioning information and to the user identifier or the device identifier (e.g., in step 714). Further, also in step 714, transaction system 130 may package the portions of the provisioning information and the account data into a response, which transaction system 130 may transmit across network 120 to the network-connected device.

The network-connected device, such as client device 102, may receive the response, and may perform operations that populate the launched remittance interface with corresponding portions of the provisioning information and the account information, e.g., as described in reference to remittance interface 360 of FIG. 3D. As described herein, the populated portions of the remittance interface may specify any of the exemplary parameter values described herein, which characterize the candidate remittance transaction capable of initiation during a corresponding temporal interval.

Further, in some instances, the user of the network-connected device, e.g., user 101, may provide additional input to the network-connected device that selects one, or more, of the candidate remittance transactions for initiation based either on the populated parameter values, or in accordance with one or more user-specified modifications to these populated parameter values. In some instances, the network-connected device may package information identifying the one or more selected remittance transactions into a corresponding initiation request, along with the user identifier and/or the device identifier, and the network-connected device may transmit the initiation request across network 120 to transaction system 130.

Referring back to FIG. 7, transaction system 130 may receive the initiation request, which identifies the one or more candidate remittance transactions selected for initiation, and which includes the user identifier and/or the device identifier (e.g., in step 716). In some instances, transaction system 130 may perform any of the exemplary processes described to initiate the each of the selected remittance transactions in based on corresponding portions of the provisioning information and the associated account information, e.g., in conjunction within one or more network-connected computing systems associated with a remittance network, such as remittance network system 150 (e.g., in step 718). Exemplary process 700 is then complete in step 720.

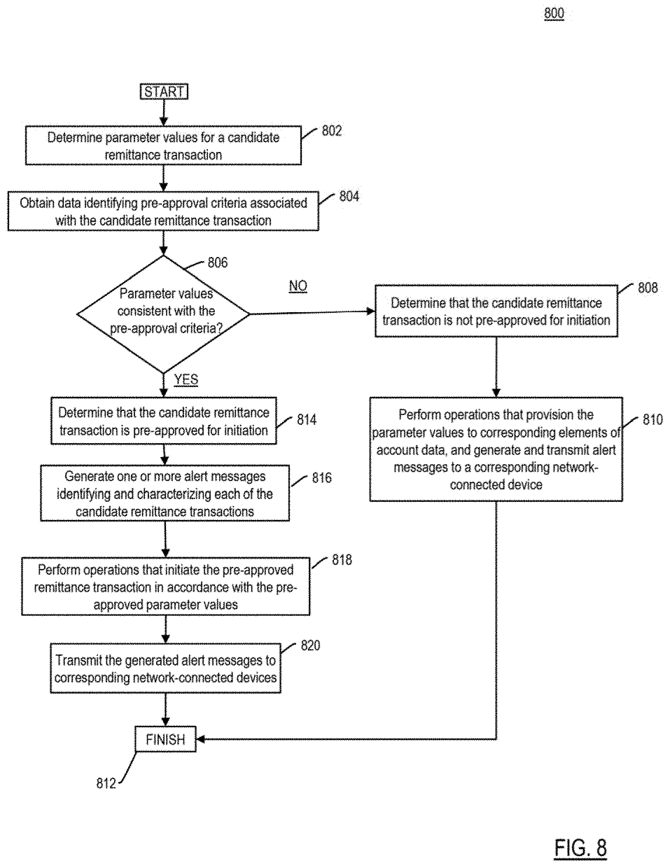

FIG. 8 is a flowchart of an additional exemplary process 800 for dynamically provisioning and initiating exchanges of data between network-connected devices and systems based on aggregated contextual information. In some examples, a network-connected computing system, such as transaction system 130 of FIG. 1, may perform one or more of the exemplary steps of process 800.

Referring to FIG. 8, transaction system 130 may perform any of the exemplary processes described herein to determine parameter values for a candidate remittance transaction that is capable of initiation by, or on behalf of, a corresponding user of transaction system 130 during a future temporal interval and further, that is consistent with one or more constraints and satisfy at least one alert criterion (e.g., in step 802). For example, and as described herein, the candidate remittance transaction may be associated with a corresponding user, such as user 101, and the parameter values for each of the candidate remittance transactions may include, but are not limited to, an identifier of a source currency and a destination currency, a remitted amount of the source, a currently quoted exchange rate, an identifier of a source account capable of funding the remitted amount, and an identifier of a destination account.

In step 804, transaction system 130 may perform operations that obtain data characterizing one or more pre-approval criteria established and maintained by the user associated with the candidate remittance transaction (e.g., as maintained on behalf of user 101 within pre-approval criteria 508 of FIG. 5). As described herein, the established and maintained pre-approval criteria may specify threshold values associated with one or more pre-approved remittance transactions, such as, but not limited to, a maximum remitted amount of a source currency, a maximum exchange rate between the source currency and one or more destination currencies, or a maximum, or minimum, delay between successively initiated remittance transactions. In other examples, the established and maintained pre-approval criteria may specify temporal intervals during which the user, such as user 101, pre-approved remittance transactions for initiation using any of the exemplary processes described herein. Additionally, or alternatively, the pre-approval criteria may identify one or more specific, pre-approved parameter values such as, but not limited to, a pre-approved destination currency or a pre-approved destination account.

Transaction system 130 may perform any of the exemplary processes described herein to determine whether the parameter values that characterize the candidate remittance transaction are consistent with the one or more pre-approval criteria (e.g., in step 806). For example, if transaction system 130 were to determine that one of the parameter values is inconsistent with at least one of the pre-approval criteria (e.g., step 806; NO), transaction system 130 may determine that the candidate remittance transaction is not pre-approved for initiation (e.g., in step 808). Transaction system 130 may further perform any of the exemplary processes described herein to provision the parameter values of the candidate remittance transaction to corresponding elements of account data, and to generate and transmit one or more alert messages to a corresponding network-connected device operated by a user associated with the pre-approval criteria, such as client device 102 operated by user 101 (e.g., in step 810). Exemplary process 800 is then complete in step 812.

Alternatively, if transaction system 130 were to determine that the parameter values are consistent with each of the pre-approval criteria (e.g., step 806; YES), transaction system 130 may determine that the candidate remittance transaction is pre-approved for initiation in accordance with the now-preapproved transaction values (e.g., in step 814).

Transaction system 130 may also perform any of the exemplary processes described herein to generate one or more alert messages identifying and characterizing each of pre-approved remittance transaction (e.g., in step 816). In some instances, and as described herein, transaction system 130 may generate the alert messages in accordance with one or more alert and notification preferences established by the user, e.g., user 101, associated with the pre-approved remittance transaction, e.g., based on locally maintained profile data and corresponding template data.

Further, transaction system 130 may perform any of the exemplary processes described to initiate the pre-approved remittance transaction in based on corresponding portions of the pre-approved parameter values, e.g., in conjunction within one or more network-connected computing systems associated with a remittance network, such as remittance network system 150 (e.g., in step 818). Transaction system 130 may also perform any of the exemplary processes described herein to transmit the generated alert messages to the network-connected device associated with the pre-approved remittance transaction and the obtained pre-approval criteria, such as client device 102 operated by user 101 (e.g., in step 820). In some instances, client device 102 may receive the generated alert messages, and executed application programs consistent with the alert and notification preferences of user 101 may render respective ones of the alert messages for presentation within a digital interface. Exemplary process 800 is the complete in step 812.
III. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification, including, but not limited to, remittance application 108, application programs 138, predictive engine 140, transaction provisioning engine 142, remittance engine 144, API 204, aggregation module 206, initiation module 210, consistency module 222, message generation module 228, routing module 236, API 238, initiation module 240, interface element generation module 244, routing module 339, API 340, API 405, and pre-approval module 506, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a communications unit;
a storage unit storing instructions; and
at least one processor coupled to the communications unit and the storage unit, the at least one processor being configured to execute the instructions to:
obtain (i) first data identifying one or more first exchanges of data initiated during a first temporal interval, (ii) second data identifying a current value of a parameter that characterizes the one or more first data exchanges, and (iii) third data identifying a status of an account involved in the one or more first data exchanges;
based on the first, second, and third data, compute a value indicative of a probability of an initiation of a second exchange of data involving the account during a second temporal interval; and
when the computed value is consistent with at least one alert criterion, generate and transmit, to a device via the communications unit, a first signal that includes alert data characterizing the second data exchange, the first signal comprising information that instructs the device to display, via a display unit, a graphical representation of the alert data within a corresponding portion of an interface.

2. The apparatus of claim 1, wherein the at least one processor is further configured to receive a second signal from an external computing system via the communications unit, the second signal comprising a portion of at least one of the first data, the second data, or the third data.

3. The apparatus of claim 1, wherein the at least one processor is further configured to perform operations that load a portion of at least one of the first data, the second data, or the third data from the storage unit.

4. The apparatus of claim 1, wherein:
the at least one alert criterion comprises a threshold probability value; and
the at least one processor is further configured to:
determine that the computed value exceeds the threshold probability value; and
generate and transmit the first signal to the device via the communications unit when the computed value exceeds the threshold probability value.

5. The apparatus of claim 1, wherein:
the at least one processor is further configured to determine parameter values that characterize the second data exchange based on an application of one or more of a statistical algorithm, an adaptive classification model, a machine learning algorithm, or an artificial neural network model to portions of the first data, the second data, and the third data;
the determined parameter values include the current value of the parameter that characterizes the one or more first data exchanges; and
the current parameter value is valid during the second temporal interval.

6. The apparatus of claim 5, wherein the at least one processor is further configured to:
load, from the storage unit, fourth data characterizing a constraint imposed on the initiation of the second data exchange during the second temporal interval;
establish that each of the determined parameter values is consistent with the constraint; and
generate and transmit the first signal to the device via the communications unit when the computed value is consistent with the at least one alert criterion, and when each of the determined parameter values is consistent with the constraint.

7. The apparatus of claim 6, wherein the at least one processor is further configured to:
when the computed value is consistent with the at least one alert criterion, and when each of the parameter values is consistent with the constraint, generate and store, within the storage unit, provisioning information that characterizes the second data exchange, the provisioning information comprising the determined parameter values;
generate modified alert data that characterizes the second data exchange and that references the provisioning information; and
generate and transmit, to the device via the communications unit, a second signal that includes the modified alert data, the second signal comprising information that instructs the device to display, via the display unit, a graphical representation of the modified alert data within a corresponding portion of the interface.

8. The apparatus of claim 7, wherein the at least one processor is further configured to:
receive, via the communications unit, a third signal from the device, the third signal comprising a request to populate an additional interface with the provisioning information;
in response to the request, load the provisioning information from the storage unit and generate response data that includes the provisioning information;
generate and transmit, via the communications unit, a fourth signal to the device that includes the response data, the fourth signal comprising information that instructs the device to perform operations that populate elements of the additional interface with corresponding portions of the provisioning information.

9. The apparatus of claim 7, wherein the at least one processor is further configured to:
receive, from the device via the communications unit, a third signal that includes a request to initiate the second data exchange;
based on the received request, load the provisioning information from the storage unit and extract the determined parameter values characterizing the second data exchange from the provisioning information; and
perform operations that initiate the second data exchange in accordance with the extracted parameter values.

10. The apparatus of claim 5, wherein the at least one processor is further configured to:
load, from the storage unit, data characterizing a pre-approval criterion associated with the second data exchange;
establish that each of the determined parameter values is consistent with the pre-approval criterion;
based on the established consistency, perform operations that initiate the second data exchange in accordance with the determined parameter values, the second data exchange being initiated without input from the device.

11. The apparatus of claim 1, wherein the at least one processor is further configured to compute the value based on an application of one or more of a statistical algorithm, an adaptive classification model, a machine learning algorithm, or an artificial neural network model to portions of the first data, the second data, and the third data.

12. A computer-implemented method, comprising:
obtaining, by one or more processors, (i) first data identifying one or more first exchanges of data initiated during a first temporal interval, (ii) second data identifying a current value of a parameter that characterizes the one or more first data exchanges, and (iii) third data identifying a status of an account involved in the one or more first data exchanges;
based on the first, second, and third data, computing, by the one or more processors, a value indicative of a probability of an initiation of a second exchange of data involving the account during a second temporal interval; and
when the computed value is consistent with at least one alert criterion, generating and transmitting, by the one or more processors, a first signal that includes alert data characterizing the second data exchange to a device, the first signal comprising information that instructs the device to display, via a display unit, a graphical representation of the alert data within a corresponding portion of an interface.

13. An apparatus, comprising:
a communications unit;
a storage unit storing instructions; and
at least one processor coupled to the communications unit and the storage unit, the at least one processor being configured to execute the instructions to:
obtain (i) first data identifying one or more first exchanges of data initiated during a first temporal interval, (ii) second data identifying a current value of a parameter that characterizes the one or more first data exchanges, and (iii) third data identifying a status of an account involved in the one or more first data exchanges;
based on the first, second, and third data, compute a value indicative of a probability of an initiation of a second exchange of data involving the account during a second temporal interval;
when the computed value is consistent with at least one alert criteria, perform operations that initiate the second data exchange in accordance with the current value of the first parameter, the second data exchange being initiated without input from a device associated with the account; and
generate and transmit, to the device via the communications unit, a first signal that includes alert data characterizing the initiated second data exchange, the first signal comprising information that instructs the device to display, via a display unit, a graphical representation of the alert data within a corresponding portion of an interface.

14. The apparatus of claim 13, wherein:
the at least one processor is further configured to determine parameter values that characterize the second data exchange based on an application of one or more of a statistical algorithm, an adaptive classification model, a machine learning algorithm, or an artificial neural network model to portions of the first data, the second data, and the third data; and
the determined parameter values include the current value of the parameter that characterizes the one or more first data exchanges.

15. The apparatus of claim 14, wherein the at least one processor is further configured to:
load, from the storage unit, fourth data characterizing a constraint imposed on an initiation of the second data exchange during the second temporal interval;
establish that each of the determined parameter values is consistent with the constraint; and
generate and transmit the first signal to the device via the communications unit when the computed value is consistent with at least one alert criterion, and when each of the determined parameter values is consistent with the constraint.

16. The apparatus of claim 14, wherein the at least one processor is further configured to:
load, from the storage unit, data characterizing a pre-approval criterion associated with the second data exchange;
establish that each of the determined parameter values is consistent with the pre-approval criterion; and
based on the established consistency, perform operations that initiate the second data exchange in accordance with the determined parameter values, the second data exchange being initiated without input from the device.

17. The apparatus of claim 16, wherein the at least one processor is further configured to:
receive a second signal from the device via the communications unit, the second signal comprising registration data that specifies the pre-approval criterion; and
storing the pre-approval criterion and an identifier of the device within the storage unit.

18. The apparatus of claim 13, wherein the at least one processor is further configured to compute the value based on an application of one or more of a statistical algorithm, an adaptive classification model, a machine learning algorithm, or an artificial neural network model to portions of the first data, the second data, and the third data.

19. The apparatus of claim 13, wherein the current parameter value is valid during the second temporal interval.

20. The apparatus of claim 13, wherein:
the at least one alert criteria comprises a threshold probability value; and
the at least one processor is further configured to:
determine that the computed value exceeds the threshold probability value; and
generate and transmit the first signal to the device via the communications unit when the computed value exceeds the threshold probability value.
